(19) United States
(12) Patent Application Publication
(10) Pub. No.: US 2024/0237647 A1
(43) Pub. Date: Jul. 18, 2024

(54) SPINOSYN PESTICIDAL COMPOSITIONS

(71) Applicant: Terramera,Inc., Vancouver (CA)

(72) Inventors: Hangsheng LI, Vancouver (CA); Steven LIN, Vancouver (CA)

(21) Appl. No.: 18/558,468

(22) PCT Filed: May 3, 2022
(86) PCT No.: PCT/CA2022/050685

§ 371 Date: Nov. 1, 2023

Related U.S. Application Data
(60) Provisional application No. 63/183,942, filed on May 4, 2021.

(51) Int. Cl. A01N 43/22; A01N 25/04; A01P 7/04

(52) U.S. Cl. CPC A01N 43/22; A01N 25/04; A01P 7/04

(57) ABSTRACT

Pesticidal compositions comprising a spinosyn active ingredient and a salicy late solvent operable to dissolve the spinosyn active ingredient are provided. The pesticidal composition may comprise an emulsion and/or an emulsifiable concentrate (EC) and may comprise an emulsifier. The pesticidal composition may comprise a carrier oil, such as a neutral oil, e.g. to limit potential phytotoxicity induced by the salicy late solvent. The pesticidal composition may comprise an oil-soluble saturated or unsaturated aliphatic acid dissolvable in the salicylate solvent and/or the carrier oil. The pesticidal composition may comprise one or more diluents, fragrance additives, ultraviolet light blockers, and/or other additives. The pesticidal composition may comprise a solution, emulsion, emulsifiable concentrate, and/or any other suitable composition of spinosyn active ingredient and salicylate solvent.

### CROSS-REFERENCE TO RELATED APPLICATIONS

This application claims priority to, and the benefit of, U.S. provisional patent application No. 63/183,942 filed 4 May 2021 entitled SPINOSYN PESTICIDAL COMPOSITIONS, which is incorporated by reference herein in its entirety for all purposes.

### TECHNICAL FIELD

The present disclosure relates generally to pesticidal compositions. In particular, some embodiments of the present invention relate to pesticidal compositions comprising spinosyns having improved physical and/or chemical characteristics such as those related to the physical handling and consistency, and physical and chemical stability of the composition enabling improved storage, mixing and application of the pesticidal composition such as for agricultural, horticultural, therapeutic or household pest control.

### BACKGROUND

Pesticides, including fungicides, herbicides, nematicides and insecticides, are important compositions for use in domestic, agricultural, industrial, therapeutic and commercial settings, such as to provide for control of unwanted pests and/or pathogens. Providing for effective pest control is of high importance in many such settings, since pests and/or other pathogens if not controlled can cause loss and or destruction of crops or other plants, or harm to animals, humans or other beneficial or desired organisms.

Spinosyns are a class of pesticide commonly used as insecticides and include spinosyns isolated from Saccharopolyspora spinosa culture (e.g. spinosyn A, spinosyn B, spinosyn C, spinosyn D, spinosyn E, spinosyn F, spinosyn G, spinosyn H, spinosyn J, and spinosyn K), Spinosad (a mixture of spinosyns A and D); derivatives, analogs, or substituents thereof (e.g. tetracyclic and pentacyclic spinosyn derivatives, aziridine spinosyn derivatives, C-5,6 and/or C-13,14 substituted spinosyn derivatives); spinetoram (including but not limited to XDE-175-J, XDE-175-L or other O-ethyl substituted spinosyn derivatives); and butenyl-spinosyn and derivatives, analogs, or substituents thereof (such as isolates from Saccharopolyspora pogona culture).

Spinosyns are commonly formulated, distributed, and applied via suspension concentrate (SC) formulations. Spinosyns tend to have limited solubility in aqueous solution, which impedes the development of non-SC formulations such as emulsion concentrate (EC) and solution formulations. Non-SC formulations of spinosyn active ingredients include an EC formulation of Spinosad with a solvent comprising a saturated monohydric alcohol with 1-10 carbon atoms, as described by PCT Publication No. 2021/012173, and a solution of Spinosad in oleic acid, as described by U.S. Pat. No. 6,955,818.

There is a general desire for improved pesticidal compositions comprising spinosyns having improved physical characteristics, including one or more of formulation clarity, emulsion stability, and pH, or having improved biocompatibility or reduced phytotoxicity, for example.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the present disclosure provides a pesticidal composition comprising: a spinosyn active ingredient; and a salicylate solvent operable to dissolve the spinosyn active ingredient.

In some embodiments, a ratio of spinosyn active ingredient to salicylate solvent is in a range of at least one of: about 1:1 to 1:10, 1:1 to 1:9, 1:1 to 1:8, 1:1 to 1:7, 1:1 to 1:6, 1:1 to 1:5, 1:1 to 1:4, 1:1 to 1:3, 1:1 to 1:2, 1:1 to 1:1.5, 1.25:1 to 1:10, 1.25:1 to 1:9, 1.25:1 to 1:8, 1.25:1 to 1:7, 1.25:1 to 1:6, 1.25:1 to 1:5, 1.25:1 to 1:4, 1.25:1 to 1:3, 1.25:1 to 1:2, 1.25:1 to 1:1.5, 1:2 to 1:10, 1:2 to 1:9, 1:2 to 1:8, 1:2 to 1:7, 1:2 to 1:6, 1:2 to 1:5, 1:2 to 1:4, 1:2 to 1:3, 1:3 to 1:10, 1:3 to 1:9, 1:3 to 1:8, 1:3 to 1:7, 1:3 to 1:6, 1:3 to 1:5, 1:3 to 1:4, 1:4 to 1:10, 1:4 to 1:9, 1:4 to 1:8, 1:4 to 1:7, 1:4 to 1:6, 1:4 to 1:5, 1:5 to 1:10, 1:5 to 1:9, 1:5 to 1:8, 1:5 to 1:7, 1:5 to 1:6, 1:6 to 1:10, 1:6 to 1:9, 1:6 to 1:8, 1:6 to 1:7, 1:7 to 1:10, 1:7 to 1:9, 1:7 to 1:8, 1:8 to 1:10, 1:8 to 1:9, and 1:9 to 1:10 by weight. In some embodiments, a ratio of spinosyn active ingredient to salicylate solvent is in a range of about 1:1 to 1:2.

In some embodiments, a ratio of spinosyn active ingredient to salicylate solvent is no less than at least one of: about 1:1, 1:2, 1:3, 1:4, and 1:5.

In some embodiments, the pesticidal composition comprises a pesticidal emulsion concentrate, the pesticidal composition further comprising an emulsifier. In some embodiments, the emulsifier may comprise at least about 5%, or at least about 10% or at least about 15% w/w of the pesticidal composition.

In some embodiments, the spinosyn active ingredient is in a range of at least one of: about 0.00001% to 60%, 0.00001% to 50%, 0.00001% to 40%, 0.00001% to 30%, 0.00001% to 20%, 0.00001% to 10%, 0.00001% to 15%, 0.00001% to 10%, 0.00001% to 5%, 0.00001% to 2%, 0.00001% to 1%, 0.00001% to 0.1%, 0.00001% to 0.01%, 0.00001% to 0.001%, 0.00001% to 0.0001%, 0.0001% to 60%, 0.0001% to 50%, 0.0001% to 40%, 0.0001% to 30%, 0.0001% to 20%, 0.0001% to 10%, 0.0001% to 15%, 0.0001% to 10%, 0.0001% to 5%, 0.0001% to 2%, 0.0001% to 1%, 0.0001% to 0.1%, 0.0001% to 0.01%, 0.0001% to 0.001%, 0.001% to 60%, 0.001% to 50%, 0.001% to 40%, 0.001% to 30%, 0.001% to 20%, 0.001% to 10%, 0.001% to 15%, 0.001% to 10%, 0.001% to 5%, 0.001% to 2%, 0.001% to 1%, 0.001% to 0.1%, 0.001% to 0.01%, 0.01% to 60%, 0.01% to 50%, 0.01% to 40%, 0.01% to 30%, 0.01% to 20%, 0.01% to 10%, 0.01% to 15%, 0.01% to 10%, 0.01% to 5%, 0.01% to 2%, 0.01% to 1%, 0.01% to 0.1%, 0.1% to 60%, 0.1% to 50%, 0.1% to 40%, 0.1% to 30%, 0.1% to 20%, 0.1% to 10%, 0.1% to 15%, 0.1% to 10%, 0.1% to 5%, 0.1% to 2%, 0.1% to 1%, 1% to 60%, 1% to 50%, 1% to 40%, 1% to 30%, 1% to 20%, 1% to 10%, 1% to 15%, 1% to 10%, 1% to 5%, 1% to 2%, 10% to 60%, 10% to 50%, 10% to 40%, 10% to 30%, 10% to 20%, 20% to 60%, 20% to 50%, 20% to 40%, 20% to 30%, 30% to 60%, 30% to 50%, 30% to 40%, 40% to 60%, 40% to 50%, and 50% to 60% of the pesticidal composition by weight.

In some embodiments, the spinosyn active ingredient is in a range of about 5% to 25% of the pesticidal composition by weight.

In some embodiments, the pesticidal composition comprises an oil carrier. In some embodiments, the oil carrier comprises an oil ester. In some embodiments, the oil carrier comprises a neutral oil. In some embodiments, the oil carrier comprises at least one of: a seed oil, safflower oil, sunflower oil, soybean oil, canola oil, castor oil, rapeseed oil, cottonseed oil, karanja oil, and neem oil. In some embodiments, the spinosyn active ingredient is less soluble in the oil carrier than in the salicylate solvent. In some embodiments, the spinosyn active ingredient is substantially insoluble in the oil carrier.

In some embodiments, the spinosyn active ingredient comprises at least one of: spinosyn A, spinosyn B, spinosyn C, spinosyn D, spinosyn E, spinosyn F, spinosyn G, spinosyn H, spinosyn J, another spinosyn isolate from Saccharopolyspora spinosa culture, spinosad, and derivatives or substituents thereof (including but not limited to tetracyclic and pentacyclic spinosyn derivatives, aziridine spinosyn derivatives, C-5,6 and/or C-13,14 substituted spinosyn derivatives); spinetoram (including but not limited to XDE-175-J, XDE-175-L or other O-ethyl substituted spinosyn derivatives); butenyl-spinosyn and derivatives or substituents thereof (such as isolates from Saccharopolyspora pogona culture).

In some embodiments, the salicylate solvent comprises an ester of salicylic acid. In some embodiments, salicylate solvent comprises a salicylate comprising an alcohol group. In some embodiments, the salicylate comprises an alkyl salicylic ester. In some further embodiments, the salicylate comprises an alkyl salicylic ester wherein the alkyl group comprises between about 1 and 5 carbon atoms, such as at least one of: methyl salicylate, ethyl salicylate, propyl salicylate, butyl salicylate, pentyl salicylate, and phenyl salicylate. In some embodiments, the salicylate solvent comprises wintergreen oil.

In some embodiments, the pesticidal composition additionally comprises a saturated or unsaturated aliphatic acid or an agriculturally or biologically compatible salt thereof. In some such embodiments, the saturated or unsaturated aliphatic acid or agriculturally or biologically compatible salt thereof may be operable to form a synergistic pesticidal composition in combination with the spinosyn active ingredient. In some embodiments, the saturated or unsaturated aliphatic acid or agriculturally or biologically compatible salt thereof comprises at least one of: octanoic acid, decanoic acid, and trans-3-Hexenoic acid. In some embodiments, the synergist comprises octanoic acid and decanoic acid. In some embodiments, a molar ratio of the concentrations of octanoic acid and decanoic acid is between about 1:1 and 2:1.

In some embodiments, a ratio of the spinosyn active ingredient and the saturated or unsaturated aliphatic acid or agriculturally/biologically compatible salt thereof is between about 1:5000 and 5000:1 by weight. In some embodiments, the molar ratio of the concentrations of the spinosyn active ingredient and the saturated or unsaturated aliphatic acid or agriculturally/biologically compatible salt thereof is between at least one of: about 1:1 to 1:10, 1:1 to 1:9, 1:1 to 1:8, 1:1 to 1:7, 1:1 to 1:6, 1:1 to 1:5, 1:1 to 1:4, 1:1 to 1:3, 1:1 to 1:2, 1:1 to 1:1.5, 1.25:1 to 1:10, 1.25:1 to 1:9, 1.25:1 to 1:8, 1.25:1 to 1:7, 1.25:1 to 1:6, 1.25:1 to 1:5, 1.25:1 to 1:4, 1.25:1 to 1:3, 1.25:1 to 1:2, 1.25:1 to 1:1.5, 1:2 to 1:10, 1:2 to 1:9, 1:2 to 1:8, 1:2 to 1:7, 1:2 to 1:6, 1:2 to 1:5, 1:2 to 1:4, 1:2 to 1:3, 1:3 to 1:10, 1:3 to 1:9, 1:3 to 1:8, 1:3 to 1:7, 1:3 to 1:6, 1:3 to 1:5, 1:3 to 1:4, 1:4 to 1:10, 1:4 to 1:9, 1:4 to 1:8, 1:4 to 1:7, 1:4 to 1:6, 1:4 to 1:5, 1:5 to 1:10, 1:5 to 1:9, 1:5 to 1:8, 1:5 to 1:7, 1:5 to 1:6, 1:6 to 1:10, 1:6 to 1:9, 1:6 to 1:8, 1:6 to 1:7, 1:7 to 1:10, 1:7 to 1:9, 1:7 to 1:8, 1:8 to 1:10, 1:8 to 1:9, and 1:9 to 1:10.

In some embodiments, the pesticidal composition comprises at least one of: a leaf penetration additive, a leaf spreading additive, a leaf sticking additive, a rainfastening additive, a safening additive, and an encapsulant. In some embodiments, the pesticidal composition comprises a UV blocking or absorbing additive.

Another aspect of the present disclosure provides a pesticidal emulsifiable concentrate comprising: a spinosyn active ingredient; and an oil ester solvent operable to dissolve the spinosyn active ingredient.

In some embodiments, a ratio of spinosyn active ingredient to salicylate solvent is in a range of at least one of: about 1:1 to 1:10, 1:1 to 1:9, 1:1 to 1:8, 1:1 to 1:7, 1:1 to 1:6, 1:1 to 1:5, 1:1 to 1:4, 1:1 to 1:3, 1:1 to 1:2, 1:1 to 1:1.5, 1.25:1 to 1:10, 1.25:1 to 1:9, 1.25:1 to 1:8, 1.25:1 to 1:7, 1.25:1 to 1:6, 1.25:1 to 1:5, 1.25:1 to 1:4, 1.25:1 to 1:3, 1.25:1 to 1:2, 1.25:1 to 1:1.5, 1:2 to 1:10, 1:2 to 1:9, 1:2 to 1:8, 1:2 to 1:7, 1:2 to 1:6, 1:2 to 1:5, 1:2 to 1:4, 1:2 to 1:3, 1:3 to 1:10, 1:3 to 1:9, 1:3 to 1:8, 1:3 to 1:7, 1:3 to 1:6, 1:3 to 1:5, 1:3 to 1:4, 1:4 to 1:10, 1:4 to 1:9, 1:4 to 1:8, 1:4 to 1:7, 1:4 to 1:6, 1:4 to 1:5, 1:5 to 1:10, 1:5 to 1:9, 1:5 to 1:8, 1:5 to 1:7, 1:5 to 1:6, 1:6 to 1:10, 1:6 to 1:9, 1:6 to 1:8, 1:6 to 1:7, 1:7 to 1:10, 1:7 to 1:9, 1:7 to 1:8, 1:8 to 1:10, 1:8 to 1:9, and 1:9 to 1:10 by weight.

In some embodiments, the pesticidal emulsifiable concentrate comprises an emulsifier. In some embodiments, the emulsifier comprises at least about 5%, or more particularly at least about 10%, or even more particularly at least about 15% w/w of the pesticidal emulsifiable concentrate.

In some embodiments, the spinosyn active ingredient comprises at least one of: about 0.5% to 50%. 1% to 50%, 2% to 50%, 3% to 50%, 4% to 50%, 5% to 50%, 6% to 50%, 7% to 50%, 8% to 50%, 9% to 50%, 10% to 50%, 15% to 50%, 20% to 50%, 25% to 50%, 30% to 50%, 35% to 50%, 40% to 50%, 45% to 50%, 1% to 45%, 2% to 45%, 3% to 45%, 4% to 45%, 5% to 45%, 6% to 45%, 7% to 45%, 8% to 45%, 9% to 45%, 10% to 45%, 15% to 45%, 20% to 45%, 25% to 45%, 30% to 45%, 35% to 45%, 40% to 45%, 1% to 40%, 2% to 40%, 3% to 40%, 4% to 40%, 5% to 40%, 6% to 40%, 7% to 40%, 8% to 40%, 9% to 40%, 10% to 40%, 15% to 40%, 20% to 40%, 25% to 40%, 30% to 40%, 35% to 40%, 1% to 35%, 2% to 35%, 3% to 35%, 4% to 35%, 5% to 35%, 6% to 35%, 7% to 35%, 8% to 35%, 9% to 35%, 10% to 35%, 15% to 35%, 20% to 35%, 25% to 35%, 30% to 35%, 1% to 30%, 2% to 30%, 3% to 30%, 4% to 30%, 5% to 30%, 6% to 30%, 7% to 30%, 8% to 30%, 9% to 30%, 10% to 30%, 15% to 30%, 20% to 30%, 25% to 30%, 1% to 25%, 2% to 25%, 3% to 25%, 4% to 25%, 5% to 25%, 6% to 25%, 7% to 25%, 8% to 25%, 9% to 25%, 10% to 25%, 15% to 25%, 20% to 25%, 1% to 20%, 2% to 20%, 3% to 20%, 4% to 20%, 5% to 20%, 6% to 20%, 7% to 20%, 8% to 20%, 9% to 20%, 10% to 20%, 15% to 20%, 1% to 15%, 2% to 15%, 3% to 15%, 4% to 15%, 5% to 15%, 6% to 15%, 7% to 15%, 8% to 15%, 9% to 15%, 10% to 15%, 1% to 10%, 2% to 10%, 3% to 10%, 4% to 10%, 5% to 10%, 6% to 10%, 7% to 10%, 8% to 10%, and 9% to 10% of the pesticidal emulsifiable concentrate by weight. In some embodiments, the spinosyn active ingredient is in a range of about 5% to 25% of the pesticidal emulsifiable concentrate by weight.

In some embodiments, the pesticidal emulsifiable concentrate comprises an oil carrier. In some embodiments, the oil carrier comprises an oil ester. In some embodiments, the oil carrier comprises a neutral oil. In some embodiments, the oil carrier comprises at least one of: a seed oil, safflower oil, sunflower oil, soybean oil, canola oil, cottonseed oil, castor oil, rapeseed oil, karanja oil and neem oil. In some embodiments, the spinosyn active ingredient is less soluble in the oil carrier than in the oil ester solvent. In some embodiments, the spinosyn active ingredient is substantially insoluble in the oil carrier.

In some embodiments, the spinosyn active ingredient comprises at least one of: spinosyn A, spinosyn B, spinosyn C, spinosyn D, spinosyn E, spinosyn F, spinosyn G, spinosyn H, spinosyn J, another spinosyn isolate from Saccharopolyspora spinosa culture, spinosad, and derivatives or substituents thereof (including but not limited to tetracyclic and pentacyclic spinosyn derivatives, aziridine spinosyn derivatives, C-5,6 and/or C-13,14 substituted spinosyn derivatives); spinetoram (including but not limited to XDE-175-J, XDE-175-L or other O-ethyl substituted spinosyn derivatives); butenyl-spinosyn and derivatives or substituents thereof (such as isolates from Saccharopolyspora pogona culture).

In some embodiments, the oil ester solvent comprises an ester of salicylic acid. In some embodiments, the oil ester solvent comprises a salicylate comprising an alcohol group. In some embodiments, the salicylate comprises an alkyl salicylic ester. In some further embodiments, the salicylate comprises an alkyl salicylic ester wherein the alkyl group comprises between about 1 and 5 carbon atoms, such as at least one of: methyl salicylate, ethyl salicylate, propyl salicylate, butyl salicylate, pentyl salicylate, and phenyl salicylate. In some embodiments, the oil ester solvent comprises wintergreen oil.

In some embodiments, the pesticidal emulsifiable concentrate additionally comprises a saturated or unsaturated aliphatic acid or an agriculturally or biologically compatible salt thereof. In some such embodiments, the saturated or unsaturated aliphatic acid or agriculturally or biologically compatible salt thereof may be operable to form a synergistic pesticidal composition in combination with the spinosyn active ingredient. In some embodiments, the saturated or unsaturated aliphatic acid or agriculturally or biologically compatible salt thereof comprises at least one of: octanoic acid, decanoic acid, and trans-3-Hexenoic acid. In some embodiments, the saturated or unsaturated aliphatic acid or agriculturally or biologically compatible salt thereof comprises octanoic acid and decanoic acid. In some such embodiments, a molar ratio of the concentrations of octanoic acid and decanoic acid is between about 1:1 and 2:1. In some embodiments, a ratio of the spinosyn active ingredient and the saturated or unsaturated aliphatic acid or agriculturally or biologically compatible salt thereof is between about 1:5000 and 5000:1 by weight. In some embodiments, the molar ratio of the concentrations of the spinosyn active ingredient and the saturated or unsaturated aliphatic acid or agriculturally or biologically compatible salt thereof is between at least one of: about 1:1 to 1:10, 1:1 to 1:9, 1:1 to 1:8, 1:1 to 1:7, 1:1 to 1:6, 1:1 to 1:5, 1:1 to 1:4, 1:1 to 1:3, 1:1 to 1:2, 1:1 to 1:1.5, 1.25:1 to 1:10, 1.25:1 to 1:9, 1.25:1 to 1:8, 1.25:1 to 1:7, 1.25:1 to 1:6, 1.25:1 to 1:5, 1.25:1 to 1:4, 1.25:1 to 1:3, 1.25:1 to 1:2, 1.25:1 to 1:1.5, 1:2 to 1:10, 1:2 to 1:9, 1:2 to 1:8, 1:2 to 1:7, 1:2 to 1:6, 1:2 to 1:5, 1:2 to 1:4, 1:2 to 1:3, 1:3 to 1:10, 1:3 to 1:9, 1:3 to 1:8, 1:3 to 1:7, 1:3 to 1:6, 1:3 to 1:5, 1:3 to 1:4, 1:4 to 1:10, 1:4 to 1:9, 1:4 to 1:8, 1:4 to 1:7, 1:4 to 1:6, 1:4 to 1:5, 1:5 to 1:10, 1:5 to 1:9, 1:5 to 1:8, 1:5 to 1:7, 1:5 to 1:6, 1:6 to 1:10, 1:6 to 1:9, 1:6 to 1:8, 1:6 to 1:7, 1:7 to 1:10, 1:7 to 1:9, 1:7 to 1:8, 1:8 to 1:10, 1:8 to 1:9, and 1:9 to 1:10.

In some embodiments, the pesticidal emulsifiable concentrate comprises at least one of: a leaf penetration additive, a leaf spreading additive, a leaf sticking additive, a rainfastening additive, a safening additive, and an encapsulant. In some embodiments, the pesticidal emulsifiable concentrate comprises a UV blocking or absorbing additive.

Another aspect of the present disclosure provides a method of making a diluted pesticidal composition comprising: providing a pesticidal composition which comprises a spinosyn active ingredient and a salicylate solvent as described herein; and diluting the pesticidal composition with a diluent to form a diluted pesticidal composition comprising the spinosyn active ingredient and the salicylate solvent. In some such embodiments, the salicylate solvent may comprise wintergreen oil.

Another aspect of the present disclosure provides a method of applying at least one pesticidal composition to control at least one plant pest comprising: providing a pesticidal composition which comprises a spinosyn active ingredient and a salicylate solvent as described herein; diluting the pesticidal composition with a diluent to form a diluted pesticidal composition comprising the spinosyn active ingredient and the salicylate solvent; and applying the diluted pesticidal composition to at least one plant, the locus thereof, or propagation material thereof, which is susceptible to or infested with the at least one plant pest. In some such embodiments, the salicylate solvent may comprise wintergreen oil.

Another aspect of the present disclosure provides a method of making a diluted pesticidal composition comprising: providing an emulsifiable concentrate which comprises a spinosyn active ingredient and an oil ester solvent as described herein; and diluting the emulsifiable concentrate with water to form an oil in water emulsion diluted pesticidal composition comprising the spinosyn active ingredient and the oil ester solvent. In some such embodiments, the oil ester solvent may comprise wintergreen oil.

Another aspect of the present disclosure provides a method of applying at least one pesticidal composition to control at least one plant pest comprising: providing an emulsifiable concentrate which comprises a spinosyn active ingredient and an oil ester solvent as described herein; diluting the emulsifiable concentrate with water to form an oil in water emulsion diluted pesticidal composition comprising the spinosyn active ingredient and the oil ester solvent; and applying the oil-in-water emulsion diluted pesticidal composition to at least one plant, the locus thereof, or propagation material thereof, which is susceptible to or infested with the at least one plant pest. In some such embodiments, the oil ester solvent may comprise wintergreen oil.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is a photograph of an exemplary emulsifiable concentrate according to the present disclosure.

FIG. 1B is a photograph of an exemplary emulsion prepared by diluting the emulsifiable concentrate of FIG. 1A, shown 24 hours after dilution.

FIG. 2 is a photograph of an example spray pattern of a composition applied to leaves of a cabbage plant for the purpose of the experiments of Examples 1 and 2.

FIG. 3 is a plot of exemplary dose curves for pest mortality modelled using the Hill Equation Fit for Dose Response Modelling for the emulsions of Examples 1 and 2.

FIG. 4 is a plot of exemplary dose curves for leaf damage modelled using the Hill Equation Fit for Dose Response Modelling for the emulsions of Examples 1 and 2.

FIG. 5 is a photograph of an exemplary pesticidal composition comprising a spinosyn active ingredient and a salicylate solvent prepared by dissolving spinosad in wintergreen oil in a 1:1 ratio.

FIG. 6 is a photograph of an exemplary pesticidal composition comprising a spinosyn active ingredient and a salicylate solvent prepared by dissolving spinosad in wintergreen oil in a 1:1.5 ratio.

FIG. 7 is a photograph of several exemplary emulsifiable concentrates comprising a spinosyn active ingredient and a salicylate solvent prepared by dissolving spinosad in various salicylates.

FIG. 8 is a photograph of several exemplary emulsions formed by diluting the exemplary emulsifiable concentrates of FIG. 7 in water.

### DESCRIPTION

### Introductory Generalities

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Unless defined otherwise, all technical and scientific terms used herein have the same meaning as commonly understood by one of ordinary skill in the art to which this disclosure belongs. As used herein, singular forms include plural references unless the context clearly dictates otherwise. As used herein, “comprises” or “comprising” are to be interpreted in their open-ended sense, i.e. as specifying that the stated features, elements, steps or components referred to are present, but not excluding the presence or addition of further features, elements, steps or components.

As used herein, all numerical values or numerical ranges provided expressly include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. Therefore, as used herein, where a range of values is provided, it is understood that each intervening value between the upper and lower limit of that range and any other stated or intervening value within that stated range is encompassed within embodiments of the disclosure. The upper and lower limits of these smaller ranges may independently define a smaller range of values, and it is to be understood that these smaller ranges are intended to be encompassed within embodiments of the disclosure, subject to any specifically excluded limit in the stated range.

As used herein, the terms “pesticide” or “pesticidal” or grammatical equivalents thereof, are understood to refer to any composition or substance that can be used in the control of any agricultural, natural environmental, and domestic/household pests. The terms “control” or “controlling” are meant to include, but are not limited to, any killing, inhibiting, growth regulating, or pestistatic (inhibiting or otherwise interfering with the normal life cycle of the pest) activities of a composition against a given pest. These terms include for example sterilizing activities which prevent the production or normal development of seeds, ova, sperm or spores, cause death of seeds, sperm, ova or spores, or otherwise cause severe injury to the genetic material. Further activities intended to be encompassed within the scope of the terms “control” or “controlling” include preventing larvae from developing into mature progeny, modulating the emergence of pests from eggs including preventing eclosion, degrading the egg material, suffocation, interfering with mycelial growth, reducing gut motility, inhibiting the formation of chitin, disrupting mating or sexual communication, preventing feeding (antifeedant) activity, and interfering with location of hosts, mates or nutrient-sources. The term “pesticide” includes fungicides, herbicides, nematicides, insecticides and the like. The term “pesticide” encompasses, but is not limited to, naturally occurring compounds as well as so-called “synthetic chemical pesticides” having structures or formulations that are not naturally occurring, where pesticides may be obtained by various means including, but not limited to, extraction from biological sources, chemical synthesis of the compound, and chemical modification of naturally occurring compounds obtained from biological sources.

As used herein, the terms “control” or “controlling” or grammatical equivalents thereof, are understood to encompass any pesticidal (killing) activities or pestistatic (inhibiting, repelling, deterring, and generally interfering with pest functions to prevent the damage to the host plant) activities of a pesticidal composition against a given pest. Thus, the terms “control” or “controlling” or grammatical equivalents thereof, not only include killing, but also include such activities as repelling, deterring, inhibiting or killing egg development or hatching, inhibiting maturation or development, and chemi-sterilization of larvae or adults. Repellant or deterrent activities may be the result of compounds that are poisonous, mildly toxic, or non-poisonous to pests, or may act as pheromones in the environment.

As used herein, the term “pesticidally effective amount” generally means the amount of the inventive mixtures or of compositions comprising the mixtures needed to achieve an observable effect on growth, including the effects of necrosis, death, retardation, prevention, and removal, destruction, or otherwise diminishing the occurrence and activity of the target pest organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

### Pesticidal Compositions

Aspects of the present disclosure provide pesticidal compositions comprising a spinosyn active ingredient and a salicylate solvent operable to dissolve the spinosyn active ingredient. In some embodiments, the pesticidal composition comprises an emulsion and/or an emulsifiable concentrate (EC) and comprises the spinosyn active ingredient, the oil ester solvent operable to dissolve the spinosyn active ingredient, and an emulsifier. In some embodiments, the pesticidal composition further comprises a carrier oil, such as a neutral oil. In some particular such embodiments, the carrier oil may comprise a safening additive, e.g. to limit potential phytotoxicity induced by the salicylate solvent or another component of the composition. In some embodiments the pesticidal composition further comprises a saturated or unsaturated aliphatic acid or an agriculturally or biologically compatible salt thereof, which is dissolvable in the salicylate solvent and/or the carrier oil. In at least one such embodiment, the saturated or unsaturated aliphatic acid or an agriculturally or biologically compatible salt thereof may be operable to form a synergistic pesticidal composition in combination with the spinosyn active ingredient. In a particular such embodiment, for instance, the saturated or unsaturated aliphatic acid or an agriculturally or biologically compatible salt thereof may be oil soluble. In some embodiments the pesticidal composition further comprises one or more diluents, fragrance additives, ultraviolet light blockers or absorbers, and/or other additives, e.g. as described in greater detail below. The pesticidal composition may comprise a solution, emulsion, emulsifiable concentrate, and/or any other composition of spinosyn active ingredient and salicylate solvent. In one such embodiment, the salicylate solvent comprises wintergreen oil.

Experimental assays have demonstrated that at least some spinosyns, such as spinosad, have poor solubility with many common solvents, impeding the development of emulsion and/or EC formulations comprising spinosad. Combination with further additives, such as synergists, can further impede the development of suitably stable formulations. As discussed in greater detail elsewhere herein, a potential advantage of at least some pesticidal compositions disclosed herein is that they may provide suitable stability for use as an “in-can” formulation (e.g. as a solution, emulsion, and/or emulsifiable concentrate) for combination with additives, such as diluents, and/or for application by end-users, including (optionally, in at least some embodiments) when mixed with certain additives, including, for example additives operable to form a synergistic pesticidal composition in combination with the spinosyn active ingredient.

The spinosyn active ingredient may comprise, for example, spinosyn isolate from Saccharopolyspora spinosa culture (e.g. spinosyn A, spinosyn B, spinosyn C, spinosyn D, spinosyn E, spinosyn F, spinosyn G, spinosyn H, spinosyn J, and spinosyn K), spinosad (a mixture of spinosyns A and D); derivatives, analogs, or substituents thereof (e.g. tetracyclic and pentacyclic spinosyn derivatives, aziridine spinosyn derivatives, C-5,6 and/or C-13,14 substituted spinosyn derivatives); spinetoram (including but not limited to XDE-175-J, XDE-175-L or other O-ethyl substituted spinosyn derivatives); and/or butenyl-spinosyn and derivatives, analogs, or substituents thereof (such as isolates from Saccharopolyspora pogona culture).

The salicylate solvent may comprise an aliphatic or alkyl ester of salicylic acid, such as an ester of salicylic acid and an alcohol. The alcohol may comprise a 1-5 carbon alcohol, such as methanol, ethanol, propanol, butanol, and/or pentanol; in such cases, the salicylate solvent may comprise methyl salicylate, ethyl salicylate, propyl salicylate, butyl salicylate, pentyl salicylate, and/or phenyl salicylate. In some embodiments, the salicylate solvent comprises wintergreen oil, which may comprise several components including methyl salicylate, such as when extracted from naturally occurring sources, for example.

In some embodiments, the ratio of spinosyn active ingredient to salicylate solvent is in a range of about 1:1 to 1:10, 1:1 to 1:9, 1:1 to 1:8, 1:1 to 1:7, 1:1 to 1:6, 1:1 to 1:5, 1:1 to 1:4, 1:1 to 1:3, 1:1 to 1:2, 1:1 to 1:1.5, 1.25:1 to 1:10, 1.25:1 to 1:9, 1.25:1 to 1:8, 1.25:1 to 1:7, 1.25:1 to 1:6, 1.25:1 to 1:5, 1.25:1 to 1:4, 1.25:1 to 1:3, 1.25:1 to 1:2, 1.25:1 to 1:1.5, 1:2 to 1:10, 1:2 to 1:9, 1:2 to 1:8, 1:2 to 1:7, 1:2 to 1:6, 1:2 to 1:5, 1:2 to 1:4, 1:2 to 1:3, 1:3 to 1:10, 1:3 to 1:9, 1:3 to 1:8, 1:3 to 1:7, 1:3 to 1:6, 1:3 to 1:5, 1:3 to 1:4, 1:4 to 1:10, 1:4 to 1:9, 1:4 to 1:8, 1:4 to 1:7, 1:4 to 1:6, 1:4 to 1:5, 1:5 to 1:10, 1:5 to 1:9, 1:5 to 1:8, 1:5 to 1:7, 1:5 to 1:6, 1:6 to 1:10, 1:6 to 1:9, 1:6 to 1:8, 1:6 to 1:7, 1:7 to 1:10, 1:7 to 1:9, 1:7 to 1:8, 1:8 to 1:10, 1:8 to 1:9, and/or 1:9 to 1:10. In some embodiments the ratio of spinosyn active ingredient to salicylate solvent is no less than at least one of: 1:1, 1:2, 1:3, 1:4, and/or 1:5. In some embodiments a ratio of spinosyn active ingredient to salicylate solvent in the range of about 1:1 to 1:2 is preferred. At least some salicylate solvents can induce phytotoxicity when applied to certain types of plants in sufficient concentration. In some embodiments and in at least some circumstances, ratios of spinosyn active ingredient to salicylate solvent of about 1:1 to 1:2 and/or other ratios disclosed herein (e.g. less than 1:1, 1:2, 1:3, 1:4, and/or 1:5) can allow for dilution of the pesticidal composition to produce a diluted pesticidal composition with a pesticidally effective amount of spinosyn active ingredient and a substantially non-phytotoxic amount of salicylate solvent.

In some embodiments, e.g. for at least some emulsifiable concentrate embodiments, the spinosyn active ingredient comprises about 0.5% to 50%, 1% to 50%, 2% to 50%, 3% to 50%, 4% to 50%, 5% to 50%, 6% to 50%, 7% to 50%, 8% to 50%, 9% to 50%, 10% to 50%, 15% to 50%, 20% to 50%, 25% to 50%, 30% to 50%, 35% to 50%, 40% to 50%, 45% to 50%, 1% to 45%, 2% to 45%, 3% to 45%, 4% to 45%, 5% to 45%, 6% to 45%, 7% to 45%, 8% to 45%, 9% to 45%, 10% to 45%, 15% to 45%, 20% to 45%, 25% to 45%, 30% to 45%, 35% to 45%, 40% to 45%, 1% to 40%, 2% to 40%, 3% to 40%, 4% to 40%, 5% to 40%, 6% to 40%, 7% to 40%, 8% to 40%, 9% to 40%, 10% to 40%, 15% to 40%, 20% to 40%, 25% to 40%, 30% to 40%, 35% to 40%, 1% to 35%, 2% to 35%, 3% to 35%, 4% to 35%, 5% to 35%, 6% to 35%, 7% to 35%, 8% to 35%, 9% to 35%, 10% to 35%, 15% to 35%, 20% to 35%, 25% to 35%, 30% to 35%, 1% to 30%, 2% to 30%, 3% to 30%, 4% to 30%, 5% to 30%, 6% to 30%, 7% to 30%, 8% to 30%, 9% to 30%, 10% to 30%, 15% to 30%, 20% to 30%, 25% to 30%, 1% to 25%, 2% to 25%, 3% to 25%, 4% to 25%, 5% to 25%, 6% to 25%, 7% to 25%, 8% to 25%, 9% to 25%, 10% to 25%, 15% to 25%, 20% to 25%, 1% to 20%, 2% to 20%, 3% to 20%, 4% to 20%, 5% to 20%, 6% to 20%, 7% to 20%, 8% to 20%, 9% to 20%, 10% to 20%, 15% to 20%, 1% to 15%, 2% to 15%, 3% to 15%, 4% to 15%, 5% to 15%, 6% to 15%, 7% to 15%, 8% to 15%, 9% to 15%, 10% to 15%, 1% to 10%, 2% to 10%, 3% to 10%, 4% to 10%, 5% to 10%, 6% to 10%, 7% to 10%, 8% to 10%, and/or 9% to 10% of the pesticidal composition by weight.

In some embodiments, e.g. in at least some emulsion and/or solution embodiments, the spinosyn active ingredient comprises between about 0.00001% and 60% of the pesticidal composition by weight; for instance, the spinosyn active ingredient may comprise 0.00001% to 60%, 0.00001% to 50%, 0.00001% to 40%, 0.00001% to 30%, 0.00001% to 20%, 0.00001% to 10%, 0.00001% to 15%, 0.00001% to 10%, 0.00001% to 5%, 0.00001% to 2%, 0.00001% to 1%, 0.00001% to 0.1%, 0.00001% to 0.01%, 0.00001% to 0.001%, 0.00001% to 0.0001%, 0.0001% to 60%, 0.0001% to 50%, 0.0001% to 40%, 0.0001% to 30%, 0.0001% to 20%, 0.0001% to 10%, 0.0001% to 15%, 0.0001% to 10%, 0.0001% to 5%, 0.0001% to 2%, 0.0001% to 1%, 0.0001% to 0.1%, 0.0001% to 0.01%, 0.0001% to 0.001%, 0.001% to 60%, 0.001% to 50%, 0.001% to 40%, 0.001% to 30%, 0.001% to 20%, 0.001% to 10%, 0.001% to 15%, 0.001% to 10%, 0.001% to 5%, 0.001% to 2%, 0.001% to 1%, 0.001% to 0.1%, 0.001% to 0.01%, 0.01% to 60%, 0.01% to 50%, 0.01% to 40%, 0.01% to 30%, 0.01% to 20%, 0.01% to 10%, 0.01% to 15%, 0.01% to 10%, 0.01% to 5%, 0.01% to 2%, 0.01% to 1%, 0.01% to 0.1%, 0.1% to 60%, 0.1% to 50%, 0.1% to 40%, 0.1% to 30%, 0.1% to 20%, 0.1% to 10%, 0.1% to 15%, 0.1% to 10%, 0.1% to 5%, 0.1% to 2%, 0.1% to 1%, 1% to 60%, 1% to 50%, 1% to 40%, 1% to 30%, 1% to 20%, 1% to 10%, 1% to 15%, 1% to 10%, 1% to 5%, 1% to 2%, 10% to 60%, 10% to 50%, 10% to 40%, 10% to 30%, 10% to 20%, 20% to 60%, 20% to 50%, 20% to 40%, 20% to 30%, 30% to 60%, 30% to 50%, 30% to 40%, 40% to 60%, 40% to 50%, and 50% to 60%.

In some embodiments, the spinosyn active ingredient preferably comprises about 5% to 25% of the pesticidal composition by weight (e.g. 5.5%, 13%, and/or 22.5%). For example, in at least one embodiment, the pesticidal composition comprises an emulsifiable concentrate comprising, by weight, 5.5% spinosad (a spinosyn active ingredient), 11% wintergreen oil (comprising methyl salicylate), 15% emulsifier (e.g. ethoxylated castor oil, an emulsifier blend, and/or another suitable emulsifier), 30% oil-soluble aliphatic acid (e.g. one or more of octanoic acid, decanoic acid, and trans-3 Hexenoic acid), and the remainder 38.5% carrier (e.g. a neutral oil such as safflower oil and/or a suitable diluent).

In some embodiments, a spinosyn active ingredient is dissolved in a salicylate solvent by mixing the spinosyn active ingredient and salicylate solvent, e.g. via high shear mixing. In some embodiments, sonication, vortexing, and/or heat are applied to facilitate solubility of the spinosyn active ingredient in the salicylate solvent.

In some embodiments as described herein, an emulsifier or other surfactant may be used in preparing pesticidal compositions according to aspects of the present disclosure, such as may be operable to disperse a pesticidal natural oil active ingredient in a water emulsion, for example. Suitable such surfactants can be selected by one skilled in the art. Examples of surfactants that can be used in some embodiments of the present disclosure include, but are not limited to sodium lauryl sulfate, saponin, ethoxylated alcohols, ethoxylated fatty esters, alkoxylated glycols, ethoxylated fatty acids, ethoxylated natural oils, ethoxylated castor oil, glyceryl oleates, polyethylene glycol oleyl ether, carboxylated alcohols, carboxylic acids, fatty acids, ethoxylated alkylphenols, fatty esters, sodium dodecylsulfide, other fatty acid-based surfactants, other natural or synthetic surfactants, and combinations thereof. In some embodiments, the surfactant(s) are non-ionic surfactants. In some embodiments, the surfactant(s) are cationic or anionic surfactants. In some embodiments, a surfactant may comprise two or more surface active agents used in combination. The selection of an appropriate surfactant depends upon the relevant applications and conditions of use, and selection of appropriate surfactants are known to those skilled in the art.

In some embodiments, pesticidal compositions according to aspects of the present disclosure may be provided as emulsifiable concentrates, which may comprise a convenient concentration of a pesticidal composition that comprises a mixture of water-immiscible and emulsifier (or surfactant) components. In some embodiments, suitable emulsifiers for emulsifiable concentrates may be chosen from anionic and nonionic surfactants.

In some other embodiments, the pesticidal composition may comprise an oil-in-water emulsion, wherein the emulsion comprises oily globules which are each provided with a lamellar liquid crystal coating and are dispersed in an aqueous phase, wherein each oily globule comprises at least one compound which is agriculturally active, and is individually coated with a monolamellar or oligolamellar layer comprising: (1) at least one non-ionic lipophilic surface-active agent, (2) at least one non-ionic hydrophilic surface-active agent and (3) at least one ionic surface-active agent, wherein the globules having a desired mean particle diameter, such as of less than about 800 nanometers, for example. For further information on suitable such formulation types known to those of skill in the art, reference may be made to publications such as, for example: “INSECT PEST MANAGEMENT” 2nd Edition by D. Dent, copyright CAB International (2000); and/or: “HANDBOOK OF PEST CONTROL—THE BEHAVIOR, LIFE HISTORY, AND CONTROL OF HOUSEHOLD PESTS” by Arnold Mallis, 9th Edition, copyright 2004 by GIE Media Inc.

In some emulsifiable concentrate embodiments, the emulsifier or other surfactant comprises at least about 5%, more particularly at least about 10% and yet more particularly at least about 15% of the pesticidal composition. In some oil-in-water emulsion embodiments, the emulsifier or other surfactant comprises at least 15% of the pesticidal composition, exclusive of water content.

In one aspect, a pesticidal composition according to some embodiments of the present disclosure additionally comprises one or more suitable carrier or diluent component. A suitable carrier or diluent component can be selected by one skilled in the art, depending on the particular application desired and the conditions of use of the composition. Commonly used carriers and diluents may include ethanol, isopropanol, isopropyl myristate, other alcohols, water, neutral oils such as one or more of mineral and vegetable oils (e.g. safflower oil, castor oil), and other inert carriers, such as but not limited to those listed by the EPA as a Minimal Risk Inert Pesticide Ingredients (4A) (the list of ingredients published dated December 2015 by the US EPA FIFRA 4a list published August 2004 entitled “List 4A—Minimal Risk Inert Ingredients”) or, for example, Inert Pesticide Ingredients (4B) (the US EPA FIFRA 4b list published August 2004 entitled “List 4B—Other ingredients for which EPA has sufficient information”) or under EPA regulation 40 CFR 180.950 dated May 24, 2002, or, for example, those listed by the EPA as Safer Chemical Ingredients (the list of ingredients published dated Oct. 26, 2020 entitled “Safer Chemical Ingredients List”), each of which is hereby incorporated herein in its entirety for all purposes. In at least some embodiments, the carrier and/or diluent component comprises a transesterified vegetable oil.

In some embodiments, pesticidal compositions according to aspects of the present disclosure may comprise a saturated or unsaturated aliphatic acid or an agriculturally or biologically compatible salt thereof, such as may be operable to form a synergistic pesticidal composition in combination with the spinosyn active ingredient., such as is described by PCT Publication Nos. 2019/064283 and/or 2019/064284, each incorporated herein by reference for all purposes. In some such embodiments, the saturated or unsaturated aliphatic acid or an agriculturally or biologically compatible salt thereof is soluble in at least one of the salicylate solvent and the carrier or diluent (if provided). For example, in some embodiments the saturated or unsaturated aliphatic acid or an agriculturally or biologically compatible salt thereof is oil-soluble and in particular is soluble in a carrier oil of the pesticidal composition. For instance, the saturated or unsaturated aliphatic acid or an agriculturally or biologically compatible salt thereof may comprise one or more of octanoic acid, decanoic acid, and trans-3 Hexenoic acid, each of which are soluble in oils such as safflower oil (and other suitable carrier oils). In some embodiments, the at least one saturated or unsaturated aliphatic acid or an agriculturally or biologically compatible salt thereof comprises a eutectic mixture of an oil and an aliphatic acid and/or a mixture of oil and aliphatic acid with reduced melting point (which may comprise, e.g. a mixture of two aliphatic acids), e.g. as described by U.S. Provisional Patent Application No. 63/021,228. For example, the saturated or unsaturated aliphatic acid or an agriculturally or biologically compatible salt thereof may comprise a mixture of octanoic acid and decanoic acid, e.g. in a ratio (by weight and/or by molar quantity) in a range of 1:1 to 2:1 (octanoic acid:decanoic acid). In at least one embodiment, the ratio of octanoic acid to decanoic acid is about 1.5:1.

In some embodiments, the ratio of spinosyn active ingredient to a saturated or unsaturated aliphatic acid or an agriculturally or biologically compatible salt thereof is in a range of about 1:5000 to 5000:1. For instance, the ratio may be in a range of about 1:1 to 1:10, 1:1 to 1:9, 1:1 to 1:8, 1:1 to 1:7, 1:1 to 1:6, 1:1 to 1:5, 1:1 to 1:4, 1:1 to 1:3, 1:1 to 1:2, 1:1 to 1:1.5, 1.25:1 to 1:10, 1.25:1 to 1:9, 1.25:1 to 1:8, 1.25:1 to 1:7, 1.25:1 to 1:6, 1.25:1 to 1:5, 1.25:1 to 1:4, 1.25:1 to 1:3, 1.25:1 to 1:2, 1.25:1 to 1:1.5, 1:2 to 1:10, 1:2 to 1:9, 1:2 to 1:8, 1:2 to 1:7, 1:2 to 1:6, 1:2 to 1:5, 1:2 to 1:4, 1:2 to 1:3, 1:3 to 1:10, 1:3 to 1:9, 1:3 to 1:8, 1:3 to 1:7, 1:3 to 1:6, 1:3 to 1:5, 1:3 to 1:4, 1:4 to 1:10, 1:4 to 1:9, 1:4 to 1:8, 1:4 to 1:7, 1:4 to 1:6, 1:4 to 1:5, 1:5 to 1:10, 1:5 to 1:9, 1:5 to 1:8, 1:5 to 1:7, 1:5 to 1:6, 1:6 to 1:10, 1:6 to 1:9, 1:6 to 1:8, 1:6 to 1:7, 1:7 to 1:10, 1:7 to 1:9, 1:7 to 1:8, 1:8 to 1:10, 1:8 to 1:9, and/or 1:9 to 1:10. In some embodiments, a ratio of about 1:2 to 1:10 is preferred, such as a ratio of about 1:3, 1:5, and/or 1:8. In some embodiments, including but not limited to at least some pesticidal compositions comprising spinosad and one or more of octanoic acid, decanoic acid, and trans-3-Hexenoic acid, a ratio of about 1:8 is preferred. For example, an embodiment may comprise a spinosyn active ingredient and a mixture of octanoic acid and decanoic acid in about 1:8 by weight (spinosyn active ingredient:octanoic and decanoic acids) wherein the octanoic acid and decanoic acid are in about a 1.5:1 ratio (octanoic acid:decanoic acid), resulting in a 1:4.8 ratio for the spinosyn active ingredient to octanoic acid and a 1:3.2 ratio for the spinosyn active ingredient to decanoic acid.

In some embodiments, pesticidal compositions described in this disclosure may also be provided with phytologically-acceptable inert ingredients to provide or complement a carrier and can be formulated into, for example, concentrated emulsions, dusts, emulsifiable concentrates, gels, granules, microencapsulations, seed treatments, suspension concentrates, suspension emulsions, and pellets, for example. For further information on suitable such formulation types known to those of skill in the art, reference may be made to publications such as, for example: “CATALOGUE OF PESTICIDE FORMULATION TYPES AND INTERNATIONAL CODING SYSTEM” Technical Monograph No 2, 5th Edition by CropLife International (2002).

In some embodiments, pesticidal compositions according to aspects of the present disclosure may be applied as aqueous suspensions or emulsions prepared from concentrated formulations of such compositions. Such water-soluble, water-suspendable, or emulsifiable formulations may be provided as liquids typically known as emulsifiable concentrates, aqueous suspensions or oil suspensions. In an alternative embodiment, pesticidal compositions may alternatively be provided as solids, typically known as wettable powders, or water dispersible granules. In such embodiments, wettable powders, which may be compacted to form water dispersible granules, comprise an intimate mixture of the pesticide composition, a carrier, and surfactants. In some such embodiments, a carrier may typically be chosen from among: attapulgite and montmorillonite clay, diatomaceous earth, or purified silicates, for example. Effective surfactants for wettable powders and/or granules, which may typically comprise from about 0.5% to about 20% of the wettable powder/granule, may comprise sulfonated lignins, condensed naphthalenesulfonates, naphthalenesulfonates, alkylbenzenesulfonates, alkyl sulfates, and nonionic surfactants such as ethylene oxide adducts of alkyl phenols, for example. For instance, in some embodiments the pesticidal composition comprises an amount of wetting agent in a range of about 1-3% of the pesticidal composition by weight and dispersing agent in a range of about 3-15% by weight.

In some alternative embodiments, pesticidal compositions according to aspects of the present disclosure may be applied as granular formulations that are particularly useful for applications to soil. Exemplary such granular formulations may contain the pesticide composition dispersed in a carrier that comprises clay or a similar substance. Such formulations may typically be prepared by dissolving the pesticide composition in a suitable solvent and applying it to a granular carrier which has been pre-formed to the appropriate particle size, such as in the range of from about 0.5 to 3 mm. Such formulations may also be formulated by making a dough or paste of the carrier and pesticide composition and crushing and drying to obtain the desired granular particle size.

In some further embodiments, dusts, granules, gels or particles containing a pesticidal composition may be prepared by intimately mixing the pesticidal composition with a suitable dust, granular, gel or particulate agricultural carrier, such as kaolin clay, ground volcanic rock, peat, cellulose, clays, hydrogels, charcoal, and the like, for example. Dusts, granules, gels or particles can be applied as suitable, such as: as a seed dressing, soil amendment, top dressing, or as a foliar application with a dust blowing machine in the case of dusts, for example.

In some embodiments, pesticidal compositions may also be applied to treatment loci in the form of an aerosol formulation. In such formulations, the pesticidal composition may typically be dissolved or dispersed in an aerosol carrier, such as a pressure-generating propellant mixture. The aerosol formulation may be packaged in or compressed within a container from which the mixture is dispensed through an atomizing valve, for example.

### Other Formulation Components

In some embodiments, when the pesticidal compositions disclosed in this disclosure are used in a formulation, such formulation may also contain other components. These components include, but are not limited to, (for greater clarity, the following is a non-exhaustive and non-mutually exclusive list) wetters, spreaders, stickers, penetrants, buffers, sequestering agents, drift reduction agents, compatibility agents, safeners, anti-foam agents, cleaning agents, rheology modifying agents, stabilizers, dispersing agents, ultraviolet light (UV) blockers (which may include reflective and/or absorbent materials), and emulsifiers. A few exemplary such additional formulation components are described below.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank to reduce the wetting time of wettable powders and to improve the penetration of water into water-dispersible granules. Examples of wetting agents used in wettable powder, suspension concentrate, and water-dispersible granule formulations are: sodium lauryl sulphate; sodium dioctyl sulphosuccinate; alkyl phenol ethoxylates; and aliphatic alcohol ethoxylates.

A dispersing agent is a substance which adsorbs onto the surface of particles and helps to preserve the state of dispersion of the particles and prevents them from reaggregating. Dispersing agents are added to agrochemical formulations to facilitate dispersion and suspension during manufacture, and to ensure the particles redisperse into water in a spray tank. They are widely used in wettable powders, suspension concentrates, and water-dispersible granules. Surfactants that are used as dispersing agents have the ability to adsorb strongly onto a particle surface and provide a charged or steric barrier to reaggregation of particles. The most commonly used surfactants are anionic, non-ionic, or mixtures of the two types. For wettable powder formulations, the most common dispersing agents are sodium lignosulphonates. For suspension concentrates, very good adsorption and stabilization are obtained using polyelectrolytes, such as sodium naphthalene sulphonate formaldehyde condensates. Tristyrylphenol ethoxylate phosphate esters are also used. Non-ionic surfactants such as alkylarylethylene oxide condensates and EO-PO block copolymers are sometimes combined with anionic surfactants as dispersing agents for suspension concentrates. In recent years, new types of very high molecular weight polymeric surfactants have been developed as dispersing agents. These have very long hydrophobic ‘backbones’ and a large number of ethylene oxide chains forming the ‘teeth’ of a ‘comb’ surfactant, and may comprise, for example, oligomeric polymers, comb graft copolymers, block copolymers (such as A-B-A tri-block copolymers), star polymers, and/or other polymeric surfactants. These high molecular weight polymers can give very good long-term stability to suspension concentrates because the hydrophobic backbones have many anchoring points onto the particle surfaces. Examples of dispersing agents used in agrochemical formulations are: sodium lignosulphonates; sodium naphthalene sulphonate formaldehyde condensates; tristyrylphenol ethoxylate phosphate esters; aliphatic alcohol ethoxylates:alkyl ethoxylates; EO-PO block copolymers; and graft copolymers.

An emulsifying agent is a substance which stabilizes a suspension of droplets of one liquid phase in another liquid phase. Without the emulsifying agent the two liquids would typically separate into two immiscible liquid phases. Exemplary commonly used emulsifier blends may contain alkylphenol or aliphatic alcohol with 12 or more ethylene oxide units and the oil-soluble calcium salt of dodecylbenzene sulphonic acid for example. In some embodiments, a range of hydrophile-lipophile balance (“HLB”) values from 8 to 18 will normally provide good stable emulsions. Emulsion stability can sometimes be improved by the addition of a small amount of an EO-PO block copolymer surfactant.

A solubilizing agent is a surfactant which will form micelles in water at concentrations above the critical micelle concentration. The micelles are then able to dissolve or solubilize water-insoluble materials inside the hydrophobic part of the micelle. Exemplary types of surfactants usually used for solubilization include non-ionics: sorbitan monooleates; sorbitan monooleate ethoxylates; and methyl oleate esters.

Thickeners or gelling agents may be typically used mainly in the formulation of suspension concentrates, emulsions and suspoemulsions to modify the rheology or flow properties of the liquid and to prevent separation and settling of the dispersed particles or droplets. Thickening, gelling, and anti-settling agents generally fall into two categories, namely water-insoluble particulates and water-soluble polymers. In some examples, it is possible to produce suspension concentrate formulations using clays and silicas. Examples of these types of materials, include, but are not limited to, montmorillonite, e.g. bentonite; magnesium aluminum silicate; and attapulgite. Water-soluble polysaccharides have been used as thickening-gelling agents for many years. The types of polysaccharides most commonly used are natural extracts of seeds and seaweeds are synthetic derivatives of cellulose. Examples of these types of materials include, but are not limited to, guar gum; locust bean gum; carrageenan; alginates; methyl cellulose; CMC thickeners such as sodium carboxymethyl cellulose (SCMC); hydroxyethyl cellulose (HEC). Other types of anti-settling agents are based on modified starches, polyacrylates, polyvinyl alcohol, polyethylene oxide and xanthan gum.

The presence of surfactants, which lower interfacial tension, often causes water-based formulations to foam during mixing operations in production and in application of a pesticidal composition through a spray tank. In order to reduce the tendency to foam, anti-foam agents are often added either during the production stage or before filling into bottles. Generally, there are two types of anti-foam agents, namely silicones and non-silicones. Silicones may usually comprise aqueous emulsions of dimethyl polysiloxane while the non-silicone anti-foam agents comprise water-insoluble oils, such as octanol and nonanol, or silica. In both cases, the function of the anti-foam agent is to displace the surfactant from the air-water interface. For further information on suitable such other formulation components known to those of skill in the art, reference may be made to publications such as, for example: “CHEMISTRY AND TECHNOLOGY OF AGROCHEMICAL FORMULATIONS” edited by D. A. Knowles, copyright 1998 by Kluwer Academic Publishers; and/or: “INSECTICIDES IN AGRICULTURE AND ENVIRONMENT—RETROSPECTS AND PROSPECTS” by A. S. Perry, I. Yamamoto, I. Ishaaya, and R. Perry, copyright 1998 by Springer-Verlag.

### Applications

In some embodiments, the actual amount of a pesticidal composition to be applied to loci of pests may generally not be critical and can readily be determined by those skilled in the art through experience and/or trial and error in application rates, for example. In general, concentrations within a range of about 0.01 grams of pesticidal active ingredient per hectare to about 5000 grams of pesticidal active ingredient per hectare may commonly be used to establish a desired range of application rates expected to provide adequate control.

### EXAMPLES

Exemplary embodiments of the present invention are further described with reference to the following examples, which are intended to be illustrative and non-limiting in nature.

### Example 1

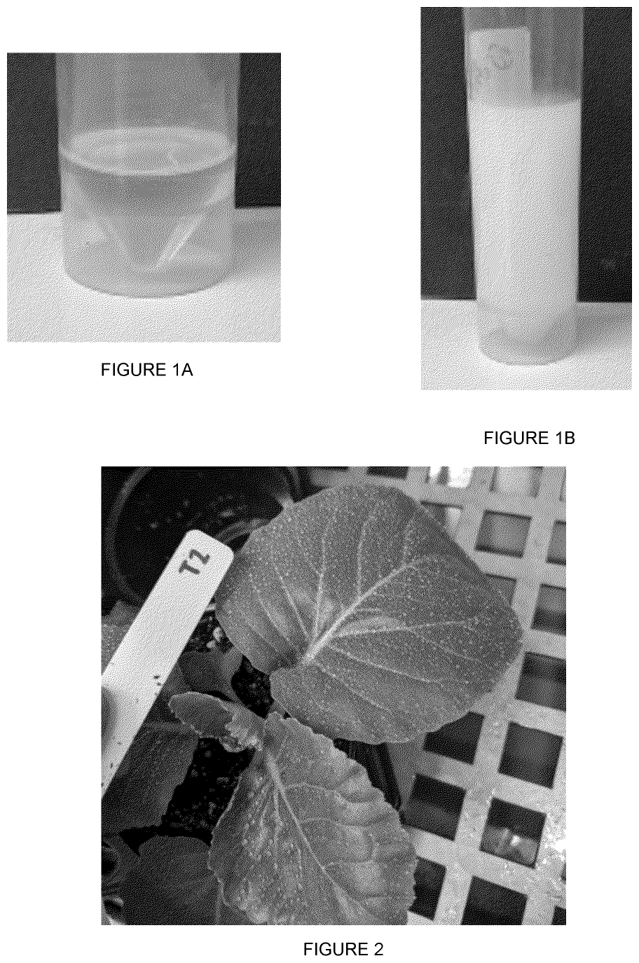

An exemplary pesticidal composition comprising an emulsifiable concentrate comprising a spinosyn active ingredient, a salicylate solvent, an emulsifier, a saturated or unsaturated aliphatic acid or an agriculturally or biologically compatible salt thereof, and a carrier was prepared according to the following description. In an open, 500 ml mixing vessel, 5.5% spinosad, 11% wintergreen oil, 15% surfactant (a blend of polyethylene glycol derivative of hydrogenated castor oil and an oleate), 30% a mixture of octanoic acid and decanoic acid (in 1.5:1 molar ratio, octanoic acid:decanoic acid), and the remainder (38.5%) safflower oil were mixed using a shear mixer at approximately 20° ° C. (Quoted percentages are all w/w.) The ratio of the octanoic/decanoic acid to spinosyn active ingredient was approximately 5.64:1 by weight (roughly a 23.2:1 molar ratio). The resulting emulsifiable concentrate was shelf-stable, with visual inspection indicating good clarity and consistency in formulation and dilution. The emulsifiable concentrate is shown in FIG. 1A.

The emulsifiable concentrate was then mixed with water to form an emulsion. The emulsifiable concentrate was mixed with water at various ratios to form emulsions with various active ingredient concentrations. For the first such emulsion, the emulsifiable concentrate was mixed with sufficient water to provide a concentration of 6.57 mg/L of spinosad. This emulsion is shown in FIG. 1B, 24 hours post-dilution, indicating good stability in emulsion. The concentration of spinosad in each subsequent emulsion was reduced by twofold dilutions, as summarized in Table 1, below.

For comparison, a control comprising only water (with no spinosad) and commercially-available formulations comprising Entrust®, a commercial suspension concentrate insecticide composition comprising spinosad and available from Corteva Agriscience (Indianapolis, IN), were also prepared. The Entrust® formulations were mixed with water only in accordance with the label and diluted to provide the same concentrations of spinosad as described above (i.e. 6.57 mg/L and further-diluted formulations). Concentrations of spinosad in each formulation are presented in Table 1, below.

TABLE 1

| | | Spinosad ppm |
|---|---|---|
| Sample ID | Treatment Group | (mg/L) |
| T01 | Control | 0 |
| T02 | Entrust ® | 6.57 |
| T03 | Entrust ® | 3.29 |
| T04 | Entrust ® | 1.64 |
| T05 | Entrust ® | 0.82 |
| T06 | Entrust ® | 0.41 |
| T07 | Entrust ® | 0.21 |
| T08 | Entrust ® | 0.10 |
| T09 | Example 1 Emulsion | 6.57 |
| T10 | Example 1 Emulsion | 3.29 |
| T11 | Example 1 Emulsion | 1.64 |
| T12 | Example 1 Emulsion | 0.82 |
| T13 | Example 1 Emulsion | 0.41 |
| T14 | Example 1 Emulsion | 0.21 |
| T15 | Example 1 Emulsion | 0.10 |

Each sample (control, Entrust®), and emulsion formulations) was then applied to 4-week-old cabbage plants, typically in the 2-4 true leaf stage. Each emulsion was applied topically to plants by spraying with an automatic sprayer using a CO2 powered spray nozzle (8004EVS, Twinjet) at approximately 36 psi (corresponding to a 3.0 V motor speed). Each emulsion was sprayed on 18 plants at a rate of 100 mL per plant (except for sample T05, which was applied to 15 plants). All formulations had a similar spray pattern with small droplets aggregated on the leaf surface (see FIG. 2). For each plant, a whole-plant bioassay was conducted to screen for lepidopterans, thereby ensuring no preexisting infestation. Plants were allowed to dry during the spray procedure by spraying one-half (i.e. 50 mL) of the application at a time. Once visible droplets had substantially dried, plants were moved into a controlled environment (i.e. a growth chamber) together, where they dried further overnight.

The following day, the plants were infested with pests, and in particular with neonate cabbage loopers. The pests had been reared on an artificial diet for approximately 24 hours. The pests were applied to leaves of the treated plant. Each plant received 10 neonate cabbage loopers—two organza bags, each containing 5 neonate cabbage loopers, were placed on each plant, each bag confined to a treated leaf of the plant by tying shut the bags.

Pest mortality and leaf damage were each assessed six days following infestation. Pest mortality is discussed first, followed by leaf damage. The two bags on each plant were assessed separately and averaged as one replicate each. Mortality was assessed as a number of live insects recovered out of the 5 initially infested per leaf. Mean mortality and associated statistics were calculated as shown in Table 2, below. The emulsion provided a one-times fold reduction at ⅛ (compared to ¼ of the label rate).

TABLE 2

| Sample ID | Treatment Group | Spinosad (mg/L) | Count | Mean (%) | StD (%) |
|---|---|---|---|---|---|
| T01 | Control | 0 | 18 | 25 | 17.57338 |
| T02 | Entrust ® | 6.57 | 18 | 85 | 13.82666 |
| T03 | Entrust ® | 3.285 | 18 | 66.11111 | 21.73067 |
| T04 | Entrust ® | 1.6425 | 18 | 60.55556 | 17.97784 |
| T05 | Entrust ® | 0.82125 | 15 | 42 | 24.26049 |
| T06 | Entrust ® | 0.410625 | 18 | 34.44444 | 10.96638 |
| T07 | Entrust ® | 0.205313 | 18 | 30 | 9.701425 |
| T08 | Entrust ® | 0.102656 | 18 | 31.11111 | 16.76442 |
| T09 | Example 1 Emulsion | 6.57 | 18 | 100 | 0 |
| T10 | Example 1 Emulsion | 3.285 | 18 | 99.44444 | 2.357023 |
| T11 | Example 1 Emulsion | 1.6425 | 18 | 89.44444 | 17.31107 |
| T12 | Example 1 Emulsion | 0.82125 | 18 | 76.11111 | 20.61949 |
| T13 | Example 1 Emulsion | 0.410625 | 18 | 49.44444 | 20.42842 |
| T14 | Example 1 Emulsion | 0.205313 | 18 | 27.77778 | 14.37136 |
| T15 | Example 1 Emulsion | 0.102656 | 18 | 28.33333 | 15.43487 |

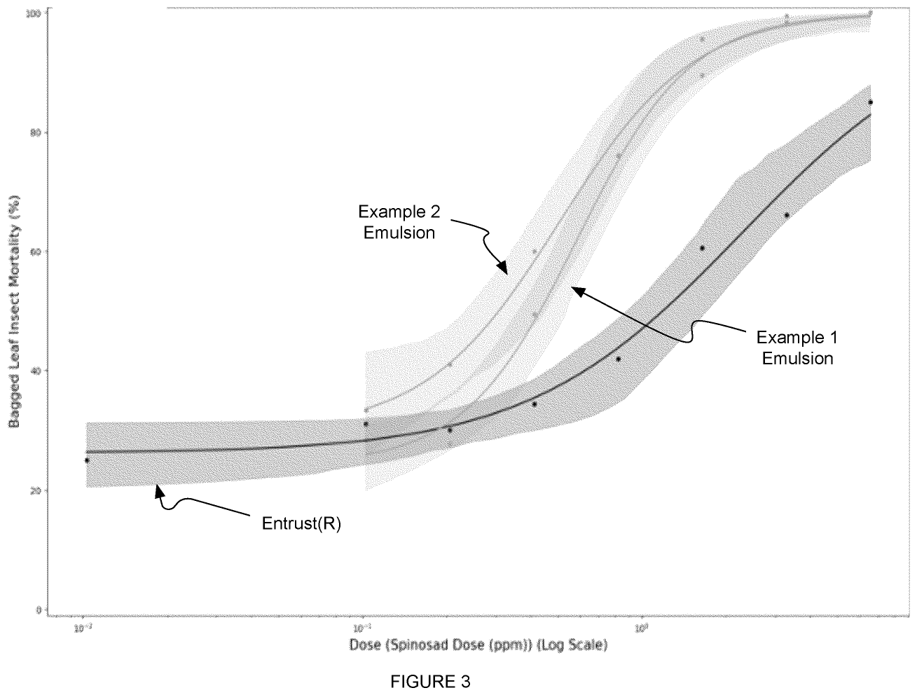

Dose curves were modelled using the Hill Equation Fit for Dose Response Modelling and are shown in FIG. 3. A summary of dose response fit values is presented in Table 3, below. Adjusted LD80 (LD80_{adj}) measures were derived from the offset and slope of the dose response curve via the equation LD80_{adj}=exp[(ln(80/20)−offset)/slope], thus taking into account baseline mortality (the mean mortality for the control sample, i.e. 25%) and shape of the dose response. The non-adjusted LD80 refers to the dose where 80% of mortality was seen in the treatment from the y-axis regardless of baseline mortality. The adjusted and non-adjusted LD80 values for the emulsion's dose curve (1.12 ppm and 0.95 ppm, respectively) were lower than those of the Entrust® curve (7.76 ppm and 5.47 ppm, respectively).

TABLE 3

| | | | | | | | Non- |
|---|---|---|---|---|---|---|---|
| Treatment | Left | Right | | | | Adjusted | adjusted |
| Group | Limit | Limit | Offset | Slope | MSE | LD80 | LD80 |
| Entrust ® | 26.17374 | 100 | −0.93598 | 1.133033 | 281.591 | 7.764867 | 5.47324 |
| Example 1 | 24.1738 | 99.88096 | 1.145028 | 2.146209 | 219.4497 | 1.118977 | 0.948911 |
| Emulsion | | | | | | | |

To compare the efficacy of the example emulsion to Entrust®, 95% confidence intervals were determined for the (non-adjusted) LD50 and LD80 measures, as shown in Table 4, below. In Table 4, “Lower LD50” corresponds to the lower bound of the 95% confidence interval for the non-adjusted LD50 measure for each treatment group, “Mean LD50” corresponds to the mean for the non-adjusted LD50 measure for each treatment group, and “Upper LD50” corresponds to the upper bound of the 95% confidence interval for the non-adjusted LD50 measure for each treatment group. “Lower LD80”, “Mean LD80”, and “Upper LD80” have similar meanings for the non-adjusted LD80 measure. The confidence intervals for each measure are non-overlapping and therefore show that the improvements in LD50 and LD80 measures (indicating increased mortality) for the example emulsion relative to Entrust® are statistically significant at the 95% confidence level.

TABLE 4

| Treatment | Lower | Mean | Upper | Lower | Mean | Upper |
|---|---|---|---|---|---|---|
| Group | LD50 | LD50 | LD50 | LD80 | LD80 | LD80 |
| Entrust ® | 0.88 | 1.19 | 1.70 | 3.76 | 5.47 | Inf |
| Example 1 | 0.36 | 0.43 | 0.54 | 0.74 | 0.95 | 1.19 |
| Emulsion | | | | | | |

The different dose curves were also compared by analyzing mean mortality using t-tests after a general linear model and p-values were adjusted using the Holm-Bonferroni method. The emulsion had a significantly (p=2.57×10⁻¹⁹) steeper slope than Entrust® and baseline mortality that was not significantly (p≈1) worse than Entrust®, as shown in Table 5, below.

TABLE 5

| | Mean | Adjusted |
|---|---|---|
| Comparison | Difference | p-value |
| SLOPE Emulsion is more | −1.06656 | 2.57E−19 |
| effective than Entrust ® | | |
| INTERCEPT Emulsion is not | 3.229115 | 1 |
| worse than Entrust ® | | |

Turning now to leaf damage, a 6-point scale was used to assess leaf damage. A score of 0 corresponds to 0-10% leaf damage, a score of 1 corresponds to 10-20% leaf tissue consumed by pests (referred to as “leaf damage” for convenience), a score of 2 corresponds to 20-40% leaf damage, a score of 3 corresponds to 40-60% leaf damage, a score of 4 corresponds to 60-80% leaf damage, and a score of 5 corresponds to 80-100% leaf damage. Scores were assigned by visual inspection. For the purposes of analysis, the upper end of each range was used (e.g. a score of 1 corresponds to 20% leaf damage, a score of 2 corresponds to 40% leaf damage, and so on), except for a score of 0, which for the purposes of analysis corresponds to 0% leaf damage. Mean leaf damage and associated statistics were calculated as shown in Table 6, below.

TABLE 6

| Sample ID | Treatment Group | Spinosad (mg/L) | Count | Mean (%) | StD (%) |
|---|---|---|---|---|---|
| T01 | Control | 0 | 18 | 47.77778 | 18.95988 |
| T02 | Entrust ® | 6.57 | 18 | 3.888889 | 6.978023 |
| T03 | Entrust ® | 3.285 | 18 | 11.66667 | 12.48529 |
| T04 | Entrust ® | 1.6425 | 18 | 22.77778 | 12.2741 |
| T05 | Entrust ® | 0.82125 | 15 | 40.66667 | 19.80861 |
| T06 | Entrust ® | 0.410625 | 18 | 50.55556 | 15.13555 |
| T07 | Entrust ® | 0.205313 | 18 | 48.33333 | 15.81139 |
| T08 | Entrust ® | 0.102656 | 18 | 47.77778 | 13.08594 |
| T09 | Example 1 Emulsion | 6.57 | 18 | 0 | 0 |
| T10 | Example 1 Emulsion | 3.285 | 18 | 0 | 0 |
| T11 | Example 1 Emulsion | 1.6425 | 18 | 2.777778 | 5.745131 |
| T12 | Example 1 Emulsion | 0.82125 | 18 | 16.66667 | 15.7181 |
| T13 | Example 1 Emulsion | 0.410625 | 18 | 27.77778 | 20.4524 |
| T14 | Example 1 Emulsion | 0.205313 | 18 | 42.22222 | 13.95605 |
| T15 | Example 1 Emulsion | 0.102656 | 18 | 50 | 14.9509 |

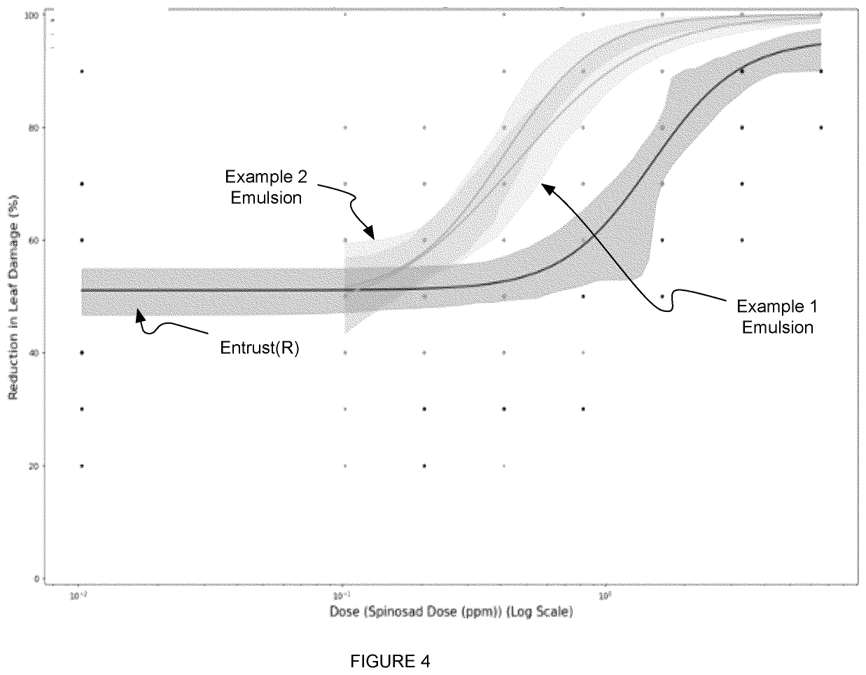

Dose curves were modelled using the Hill Equation Fit for Dose Response Modelling and are shown in FIG. 4. A summary of dose response fit values is presented in Table 7, below. Adjusted LD80 (LD80_{adj}) measures were derived from the offset and slope of the dose response curve via the equation LD80_{adj}=exp[(ln(80/20)−offset)/slope], thus taking into account baseline mortality (the mean mortality for the control sample, i.e. 47.8%) and shape of the dose response. The non-adjusted LD80 refers to the dose where 80% of mortality was seen in the treatment from the y-axis regardless of baseline mortality. The adjusted and non-adjusted LD80 values for the emulsion's dose curve (1.00 ppm and 0.60 ppm, respectively) were lower than those of the Entrust® curve (2.54 ppm and 1.89 ppm, respectively).

TABLE 7

| | | | | | | | Non- |
|---|---|---|---|---|---|---|---|
| Treatment | Left | Right | | | | Adjusted | adjusted |
| Group | Limit | Limit | Offset | Slope | MSE | LD80 | LD80 |
| Entrust ® | 51.06522 | 95.61537 | −1.02286 | 2.580113 | 206.1892 | 2.544001 | 1.887953 |
| Example 1 | 46.74165 | 100 | 1.390912 | 1.751835 | 153.1355 | 0.997367 | 0.604311 |
| Emulsion | | | | | | | |

To compare leaf damage between treatments by the example emulsion and Entrust®, 95% confidence intervals were determined for the (non-adjusted) LD80 measures, as shown in Table 8, below. In Table 8, “Lower LD80” corresponds to the lower bound of the 95% confidence interval for the non-adjusted LD80 measure for each treatment group, “Mean LD80” corresponds to the mean for the non-adjusted LD80 measure for each treatment group, and “Upper LD80” corresponds to the upper bound of the 95% confidence interval for the non-adjusted LD80 measure for each treatment group. The confidence intervals for each measure are non-overlapping and therefore show that the improvement in LD80 measure (indicating decreased leaf damage) for the example emulsion relative to Entrust® are statistically significant at the 95% confidence level.

TABLE 8

| Treatment | Lower | Mean | Upper |
|---|---|---|---|
| Group | LD80 | LD80 | LD80 |
| Entrust ® | 1.54 | 1.89 | 2.41 |
| Example 1 | 0.45 | 0.60 | 0.80 |
| Emulsion | | | |

The different dose curves were also compared by analyzing mean mortality using t-tests after a general linear model and p-values were adjusted using the Holm-Bonferroni method. The emulsion had a significantly (p=2.34×10⁻⁷) steeper slope than Entrust®, as shown in Table 9, below.

TABLE 9

| | Mean | Adjusted |
|---|---|---|
| Comparison | Difference | p-value |
| SLOPE Emulsion is more | −6.0026 | 2.34E−7 |
| effective than Entrust ® | | |
| INTERCEPT Emulsion is not | 6.236351 | 0.88715 |
| worse than Entrust ® | | |

The emulsion thus showed significantly better efficacy against cabbage looper in both survival and leaf damage than Entrust®, as shown by the LD80 confidence intervals above.

### Example 2

An exemplary pesticidal composition comprising an emulsifiable concentrate comprising a spinosyn active ingredient, a salicylate solvent, an emulsifier, an unsaturated aliphatic acid, and a carrier was prepared according to the following description. In an open, 500 ml mixing vessel, 5.5% spinosad, 11% wintergreen oil, 15% surfactant (a blend of polyethylene glycol derivative of hydrogenated castor oil and an oleate), 30% trans-3-Hexenoic acid, and the remainder (38.5%) safflower oil were mixed using a shear mixer at approximately 20° ° C. (Quoted percentages are all w/w.) The ratio of synergist to spinosyn active ingredient was approximately 5.64:1 by weight (roughly a 23.2:1 molar ratio). The resulting emulsifiable concentrate was shelf-stable, with visual inspection indicating good clarity and consistency in formulation and dilution, with appearance similar to the emulsifiable concentrate of FIG. 1A.

The resulting emulsifiable concentrate was then mixed with water to form an emulsion. The emulsifiable concentrate was mixed with water at various ratios to form emulsions with various active ingredient concentrations. For the first such emulsion, the emulsifiable concentrate was mixed with sufficient water to provide a concentration of 6.57 mg/L of spinosad. This emulsion had stability and appearance 24 hours post-dilution similar to the emulsion shown in FIG. 1B, indicating good stability in emulsion. The concentration of spinosad in each subsequent emulsion was reduced by twofold dilutions, as summarized in Table 10, below.

The experimental protocol for the emulsion of this Example 2 was the same as was followed for Example 1. The same control comprising only water (with no spinosad) and commercially-available formulations comprising Entrust®, a suspension concentrate comprising spinosad (from Corteva Agriscience, Indianapolis, IN), that were prepared for Example 1 were also used for comparison against the Example 2 emulsion. Concentrations of spinosad in each formulation are presented in Table 10, below.

TABLE 10

| | | Spinosad ppm |
|---|---|---|
| Sample ID | Treatment Group | (mg/L) |
| T01 | Control | 0 |
| T02 | Entrust ® | 6.57 |
| T03 | Entrust ® | 3.29 |
| T04 | Entrust ® | 1.64 |
| T05 | Entrust ® | 0.82 |
| T06 | Entrust ® | 0.41 |
| T07 | Entrust ® | 0.21 |
| T08 | Entrust ® | 0.10 |
| T16 | Example 2 Emulsion | 6.57 |
| T17 | Example 2 Emulsion | 3.29 |
| T18 | Example 2 Emulsion | 1.64 |
| T19 | Example 2 Emulsion | 0.82 |
| T20 | Example 2 Emulsion | 0.41 |
| T21 | Example 2 Emulsion | 0.21 |
| T22 | Example 2 Emulsion | 0.10 |

Each sample (control, Entrust®, and emulsion formulations) was then applied to 4-week-old cabbage plants, typically in the 2-4 true leaf stage. Each emulsion was applied topically to plants by spraying with an automatic sprayer using a CO2 powered spray nozzle (8004EVS, Twinjet) at approximately 36 psi (corresponding to a 3.0 V motor speed). Each emulsion was sprayed on 18 plants at a rate of 100 mL per plant (except for sample T05, which was applied to 15 plants). All formulations had a similar spray pattern with small droplets aggregated on the leaf surface (see FIG. 2). For each plant, a whole-plant bioassay was conducted to screen for lepidopterans, thereby ensuring no preexisting infestation. Plants were allowed to dry during the spray procedure by spraying one-half (i.e. 50 mL) of the application at a time. Once visible droplets had substantially dried, plants were moved into a controlled environment (i.e. a growth chamber) together, where they dried further overnight.

The following day, the plants were infested with pests, and in particular with neonate cabbage loopers. The pests had been reared on an artificial diet for approximately 24 hours. The pests were applied to leaves of the treated plant. Each plant received 10 neonate cabbage loopers—two organza bags, each containing 5 neonate cabbage loopers, were placed on each plant, each bag confined to a treated leaf of the plant by tying shut the bags.

Pest mortality and leaf damage were each assessed six days following infestation. Pest mortality is discussed first, followed by leaf damage. The two bags on each plant were assessed separately and averaged as one replicate each. Mortality was assessed as a number of live insects recovered out of the 5 initially infested per leaf. Mean mortality and associated statistics were calculated as shown in Table 11, below. The emulsion provided a two-times fold reduction up to ⅛ of the label rate (compared to ½ of the label rate).

TABLE 11

| Sample ID | Treatment Group | Spinosad (mg/L) | Count | Mean (%) | StD (%) |
|---|---|---|---|---|---|
| T01 | Control | 0 | 18 | 25 | 17.57338 |
| T02 | Entrust ® | 6.57 | 18 | 85 | 13.82666 |
| T03 | Entrust ® | 3.285 | 18 | 66.11111 | 21.73067 |
| T04 | Entrust ® | 1.6425 | 18 | 60.55556 | 17.97784 |
| T05 | Entrust ® | 0.82125 | 15 | 42 | 24.26049 |
| T06 | Entrust ® | 0.410625 | 18 | 34.44444 | 10.96638 |
| T07 | Entrust ® | 0.205313 | 18 | 30 | 9.701425 |
| T08 | Entrust ® | 0.102656 | 18 | 31.11111 | 16.76442 |
| T16 | Example 2 Emulsion | 6.57 | 18 | 100 | 0 |
| T17 | Example 2 Emulsion | 3.285 | 18 | 98.33333 | 7.071068 |
| T18 | Example 2 Emulsion | 1.6425 | 18 | 95.55556 | 9.835244 |
| T19 | Example 2 Emulsion | 0.82125 | 18 | 76.11111 | 20.90283 |
| T20 | Example 2 Emulsion | 0.410625 | 18 | 60 | 23.00895 |
| T21 | Example 2 Emulsion | 0.205313 | 18 | 41.11111 | 18.43554 |
| T22 | Example 2 Emulsion | 0.102656 | 18 | 33.33333 | 20.57983 |

Dose curves were modelled using the Hill Equation Fit for Dose Response Modelling and are shown in FIG. 3. A summary of dose response fit values is presented in Table 12, below, above. Adjusted LD80 (LD80_{adj}) measures were derived from the offset and slope of the dose response curve via the equation LD80_{adj}=exp[(ln(80/20)−offset)/slope], thus taking into account baseline mortality (the mean mortality for the control sample, i.e. 25%) and shape of the dose response. The non-adjusted LD80 refers to the dose where 80% of mortality was seen in the treatment from the y-axis regardless of baseline mortality. The adjusted and non-adjusted LD80 values for the emulsion's dose curve (1.08 ppm and 0.84 ppm, respectively) were lower than those of the Entrust® curve (7.76 ppm and 5.47 ppm, respectively).

TABLE 12

| | | | | | | | Non- |
|---|---|---|---|---|---|---|---|
| Treatment | Left | Right | | | | Adjusted | adjusted |
| Group | Limit | Limit | Offset | Slope | MSE | LD80 | LD80 |
| Entrust ® | 26.17374 | 100 | −0.93598 | 1.133033 | 281.591 | 7.764867 | 5.47324 |
| Example 2 | 30.02351 | 100 | 1.232805 | 1.823024 | 256.498 | 1.087841 | 0.840399 |
| Emulsion | | | | | | | |

To compare the efficacy of the example emulsion to Entrust®, 95% confidence intervals were determined for the (non-adjusted) LD50 and LD80 measures, as shown in Table 13, below. In Table 13, “Lower LD50” corresponds to the lower bound of the 95% confidence interval for the non-adjusted LD50 measure for each treatment group, “Mean LD50” corresponds to the mean for the non-adjusted LD50 measure for each treatment group, and “Upper LD50” corresponds to the upper bound of the 95% confidence interval for the non-adjusted LD50 measure for each treatment group. “Lower LD80”, “Mean LD80”, and “Upper LD80” have similar meanings for the non-adjusted LD80 measure. The confidence intervals for each measure are non-overlapping and therefore show that the improvements in LD50 and LD80 measures (indicating increased mortality) for the example emulsion relative to Entrust® are statistically significant at the 95% confidence level.

TABLE 13

| Treatment | Lower | Mean | Upper | Lower | Mean | Upper |
|---|---|---|---|---|---|---|
| Group | LD50 | LD50 | LD50 | LD80 | LD80 | LD80 |
| Entrust ® | 0.88 | 1.19 | 1.70 | 3.76 | 5.47 | Inf |
| Example 2 | 0.23 | 0.31 | 0.45 | 0.65 | 0.84 | 1.05 |
| Emulsion | | | | | | |

The different dose curves were also compared by analyzing mean mortality using t-tests after a general linear model and p-values were adjusted using the Holm-Bonferroni method. The emulsion had a significantly (p=6.60×10₋₁₇) steeper slope than Entrust® and baseline mortality that was not significantly (p≈1) worse than Entrust®, as shown in Table 14, below.

TABLE 14

| | Mean | Adjusted |
|---|---|---|
| Comparison | Difference | p-value |
| SLOPE Emulsion is more | −1.00522 | 6.60E−17 |
| effective than Entrust ® | | |
| INTERCEPT Emulsion is not | 2.645508 | 1 |
| worse than Entrust ® | | |

Turning now to leaf damage, a 6-point scale was used to assess leaf damage. A score of 0 corresponds to 0-10% leaf damage, a score of 1 corresponds to 10-20% leaf tissue consumed by pests (referred to as “leaf damage” for convenience), a score of 2 corresponds to 20-40% leaf damage, a score of 3 corresponds to 40-60% leaf damage, a score of 4 corresponds to 60-80% leaf damage, and a score of 5 corresponds to 80-100% leaf damage. Scores were assigned by visual inspection. For the purposes of analysis, the upper end of each range was used (e.g. a score of 1 corresponds to 20% leaf damage, a score of 2 corresponds to 40% leaf damage, and so on), except for a score of 0, which for the purposes of analysis corresponds to 0% leaf damage. Mean leaf damage and associated statistics were calculated as shown in Table 15, below.

TABLE 15

| Sample ID | Treatment Group | Spinosad (mg/L) | Count | Mean (%) | StD (%) |
|---|---|---|---|---|---|
| T01 | Control | 0 | 18 | 47.77778 | 18.95988 |
| T02 | Entrust ® | 6.57 | 18 | 3.888889 | 6.978023 |
| T03 | Entrust ® | 3.285 | 18 | 11.66667 | 12.48529 |
| T04 | Entrust ® | 1.6425 | 18 | 22.77778 | 12.2741 |
| T05 | Entrust ® | 0.82125 | 15 | 40.66667 | 19.80861 |
| T06 | Entrust ® | 0.410625 | 18 | 50.55556 | 15.13555 |
| T07 | Entrust ® | 0.205313 | 18 | 48.33333 | 15.81139 |
| T08 | Entrust ® | 0.102656 | 18 | 47.77778 | 13.08594 |
| T16 | Example 2 Emulsion | 6.57 | 18 | 0 | 0 |
| T17 | Example 2 Emulsion | 3.285 | 18 | 0 | 0 |
| T18 | Example 2 Emulsion | 1.6425 | 18 | 2.222222 | 7.320845 |
| T19 | Example 2 Emulsion | 0.82125 | 18 | 7.777778 | 8.782038 |
| T20 | Example 2 Emulsion | 0.410625 | 18 | 25 | 19.77818 |
| T21 | Example 2 Emulsion | 0.205313 | 18 | 42.22222 | 10.60275 |
| T22 | Example 2 Emulsion | 0.102656 | 18 | 48.33333 | 19.77818 |

Dose curves were modelled using the Hill Equation Fit for Dose Response Modelling and are shown in FIG. 4. A summary of dose response fit values is presented in Table 16, below. Adjusted LD80 (LD80_{adj}) measures were derived from the offset and slope of the dose response curve via the equation LD80_{adj}=exp[(ln(80/20)−offset)/slope], thus taking into account baseline mortality (the mean mortality for the control sample, i.e. 47.8%) and shape of the dose response. The non-adjusted LD80 refers to the dose where 80% of mortality was seen in the treatment from the y-axis regardless of baseline mortality. The adjusted and non-adjusted LD80 values for the emulsion's dose curve (0.73 ppm and 0.49 ppm, respectively) were lower than those of the Entrust® curve (2.54 ppm and 1.89 ppm, respectively).

TABLE 16

| | | | | | | | Non- |
|---|---|---|---|---|---|---|---|
| Treatment | Left | Right | | | | Adjusted | adjusted |
| Group | Limit | Limit | Offset | Slope | MSE | LD80 | LD80 |
| Entrust ® | 51.06522 | 95.61537 | −1.02286 | 2.580113 | 206.1892 | 2.544001 | 1.887953 |
| Example 2 | 49.88966 | 100 | 2.146176 | 2.407648 | 138.4175 | 0.729343 | 0.486038 |
| Emulsion | | | | | | | |

To compare leaf damage between treatments by the example emulsion and Entrust®, 95% confidence intervals were determined for the (non-adjusted) LD80 measures, as shown in Table 17, below. In Table 17, “Lower LD80” corresponds to the lower bound of the 95% confidence interval for the non-adjusted LD80 measure for each treatment group, “Mean LD80” corresponds to the mean for the non-adjusted LD80 measure for each treatment group, and “Upper LD80” corresponds to the upper bound of the 95% confidence interval for the non-adjusted LD80 measure for each treatment group. The confidence intervals for each measure are non-overlapping and therefore show that the improvement in LD80 measure (indicating decreased leaf damage) for the example emulsion relative to Entrust® are statistically significant at the 95% confidence level.

TABLE 17

| Treatment | Lower | Mean | Upper |
|---|---|---|---|
| Group | LD80 | LD80 | LD80 |
| Entrust ® | 1.54 | 1.89 | 2.41 |
| Example 2 | 0.40 | 0.49 | 0.59 |
| Emulsion | | | |

The different dose curves were also compared by analyzing mean mortality using t-tests after a general linear model and p-values were adjusted using the Holm-Bonferroni method. The emulsion had a significantly (p=5.62×10⁻⁷) steeper slope than Entrust®, as shown in Table 18, below.

TABLE 18

| | Mean | Adjusted |
|---|---|---|
| Comparison | Difference | p-value |
| SLOPE Emulsion is more | −5.80856 | 5.62E−07 |
| effective than Entrust ® | | |
| INTERCEPT Emulsion is not | 3.650301 | 0.760644 |
| worse than Entrust ® | | |

The emulsion thus showed significantly better efficacy against cabbage looper in both survival and leaf damage than Entrust®, as shown by the LD80 confidence intervals above.

### Example 3

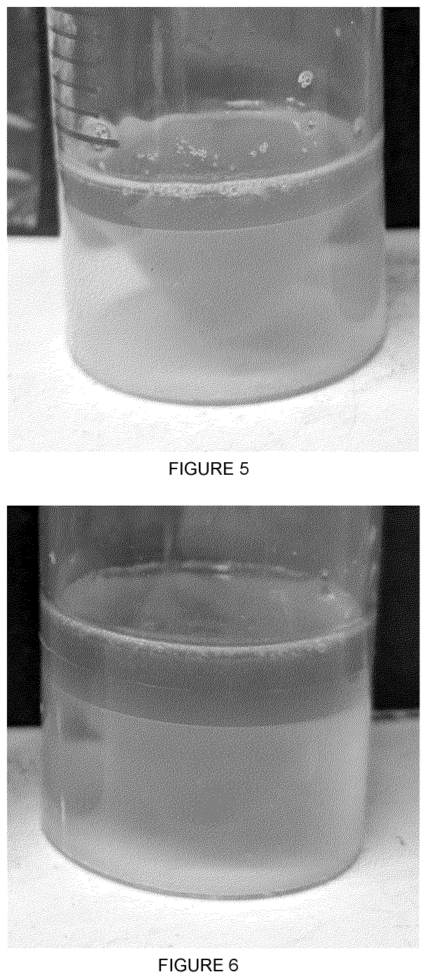

An exemplary pesticidal composition comprising a spinosyn active ingredient and a salicylate solvent was prepared by dissolving spinosad in wintergreen oil in a 1:1 ratio (by weight). The spinosad and wintergreen oil were mixed in an open, 500 ml mixing vessel. The resulting solution was shelf-stable, with visual inspection indicating good clarity and consistency in formulation and dilution without separation or crash-out during observation. The solution is shown in FIG. 5 and is considered suitable for use in, for example, an emulsifiable concentrate, emulsion, solution, and/or other pesticidal composition.

### Example 4

An exemplary pesticidal composition comprising a spinosyn active ingredient and a salicylate solvent was prepared by dissolving spinosad in wintergreen oil in a 1:1.5 ratio (by weight). The spinosad and wintergreen oil were mixed in an open, 500 ml mixing vessel. The resulting solution was shelf-stable, with visual inspection indicating good clarity and consistency in formulation and dilution without separation or crash-out during observation. The solution is shown in FIG. 6 and is considered suitable for use in, for example, an emulsifiable concentrate, emulsion, solution, and/or other pesticidal composition.

This pesticidal composition was later mixed with an emulsifier blend, octanoic acid, decanoic acid, and safflower oil to form an emulsifiable concentrate comprising 13% spinosad, 19.5% wintergreen oil, 15% emulsifier blend, 30% octanoic and decanoic acid (in approx. 1.5:1 molar ratio), and 22.5% safflower oil. (The foregoing percentages are w/w.) The resulting emulsifiable concentrate was stable. The emulsifiable concentrate was diluted with water to form an oil-in-water emulsion (at 2500 ppm of emulsifiable concentrate in water), which was also stable.

### Example 5

Exemplary pesticidal compositions comprising a spinosyn active ingredient and salicylate solvents were prepared by dissolving spinosad in a salicylate to form example solutions. In particular, spinosad was dissolved in each of methyl salicylate, ethyl salicylate, propyl salicylate, butyl salicylate, and phenyl salicylate, thus forming five example solutions, each with an 1:2 ratio of spinosad to the given salicylate by weight. For each example solution, the spinosad was mixed with the applicable salicylate in a closed, 20 ml mixing vessel. The solutions provided good clarity and consistency in formulation and dilution without separation or crash-out during observation, as described in greater detail below. The solutions are considered suitable for use in, for example, an emulsifiable concentrate, emulsion, solution, and/or other pesticidal composition.

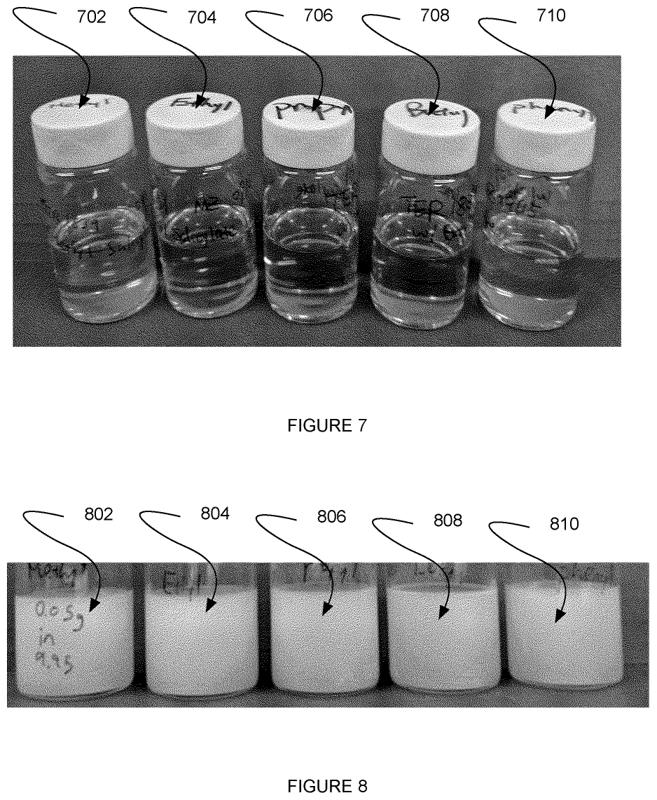

The example solutions were mixed with a surfactant, an aliphatic acid blend comprising octanoic acid and decanoic acid in a 1.5:1 w/w ratio, and safflower oil to form example pesticidal emulsifiable concentrates. The example pesticidal emulsifiable concentrates comprised approximately 5.5% spinosad, 11% salicylate, 15% surfactant, 30% aliphatic acids (comprising 18% octanoic acid and 12% decanoic acid), and 38.5% safflower oil and are shown in FIG. 7 as composition 702 (comprising methyl salicylate), composition 704 (comprising ethyl salicylate), composition 706 (comprising propyl salicylate), composition 708 (comprising butyl salicylate), and composition 710 (comprising phenyl salicylate).

The example pesticidal emulsifiable concentrates were diluted in water to form pesticidal emulsions comprising 0.5% emulsifiable concentrate and 99.5% water. The emulsions are shown in FIG. 8 two to three hours after dilution; composition 802 corresponds to composition 702, composition 804 corresponds to composition 704, composition 806 corresponds to composition 706, composition 808 corresponds to composition 708, and composition 810 corresponds to composition 710.

### Concluding Generalities

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A pesticidal composition comprising:
a spinosyn active ingredient; and
a salicylate solvent operable to dissolve the spinosyn active ingredient.

2. The pesticidal composition of claim 1 wherein a ratio of spinosyn active ingredient to salicylate solvent is in a range of at least one of: about 1:1 to 1:10, 1:1 to 1:9, 1:1 to 1:8, 1:1 to 1:7, 1:1 to 1:6, 1:1 to 1:5, 1:1 to 1:4, 1:1 to 1:3, 1:1 to 1:2, 1:1 to 1:1.5, 1.25:1 to 1:10, 1.25:1 to 1:9, 1.25:1 to 1:8, 1.25:1 to 1:7, 1.25:1 to 1:6, 1.25:1 to 1:5, 1.25:1 to 1:4, 1.25:1 to 1:3, 1.25:1 to 1:2, 1.25:1 to 1:1.5, 1:2 to 1:10, 1:2 to 1:9, 1:2 to 1:8, 1:2 to 1:7, 1:2 to 1:6, 1:2 to 1:5, 1:2 to 1:4, 1:2 to 1:3, 1:3 to 1:10, 1:3 to 1:9, 1:3 to 1:8, 1:3 to 1:7, 1:3 to 1:6, 1:3 to 1:5, 1:3 to 1:4, 1:4 to 1:10, 1:4 to 1:9, 1:4 to 1:8, 1:4 to 1:7, 1:4 to 1:6, 1:4 to 1:5, 1:5 to 1:10, 1:5 to 1:9, 1:5 to 1:8, 1:5 to 1:7, 1:5 to 1:6, 1:6 to 1:10, 1:6 to 1:9, 1:6 to 1:8, 1:6 to 1:7, 1:7 to 1:10, 1:7 to 1:9, 1:7 to 1:8, 1:8 to 1:10, 1:8 to 1:9, and 1:9 to 1:10 by weight, optionally wherein the ratio of spinosyn active ingredient to salicylate solvent is in a range of about 1:1 to 1:2, or optionally wherein a ratio of spinosyn active ingredient to salicylate solvent is no less than at least one of: about 1:1, 1:2, 1:3, 1:4, and 1:5.

3. (canceled)

4. (canceled)

5. The pesticidal composition of claim 1 wherein the pesticidal composition comprises a pesticidal emulsion concentrate, the pesticidal composition further comprising an emulsifier, optionally wherein the emulsifier comprises at least one of: at least about 5%, at least about 10% and at least about 15% w/w of the pesticidal composition.

6. (canceled)

7. The pesticidal composition of claim 1 wherein the spinosyn active ingredient is in a range of at least one of: about 0.00001% to 60%, 0.00001% to 50%, 0.00001% to 40%, 0.00001% to 30%, 0.00001% to 20%, 0.00001% to 10%, 0.00001% to 15%, 0.00001% to 10%, 0.00001% to 5%, 0.00001% to 2%, 0.00001% to 1%, 0.00001% to 0.1%, 0.00001% to 0.01%, 0.00001% to 0.001%, 0.00001% to 0.0001%, 0.0001% to 60%, 0.0001% to 50%, 0.0001% to 40%, 0.0001% to 30%, 0.0001% to 20%, 0.0001% to 10%, 0.0001% to 15%, 0.0001% to 10%, 0.0001% to 5%, 0.0001% to 2%, 0.0001% to 1%, 0.0001% to 0.1%, 0.0001% to 0.01%, 0.0001% to 0.001%, 0.001% to 60%, 0.001% to 50%, 0.001% to 40%, 0.001% to 30%, 0.001% to 20%, 0.001% to 10%, 0.001% to 15%, 0.001% to 10%, 0.001% to 5%, 0.001% to 2%, 0.001% to 1%, 0.001% to 0.1%, 0.001% to 0.01%, 0.01% to 60%, 0.01% to 50%, 0.01% to 40%, 0.01% to 30%, 0.01% to 20%, 0.01% to 10%, 0.01% to 15%, 0.01% to 10%, 0.01% to 5%, 0.01% to 2%, 0.01% to 1%, 0.01% to 0.1%, 0.1% to 60%, 0.1% to 50%, 0.1% to 40%, 0.1% to 30%, 0.1% to 20%, 0.1% to 10%, 0.1% to 15%, 0.1% to 10%, 0.1% to 5%, 0.1% to 2%, 0.1% to 1%, 1% to 60%, 1% to 50%, 1% to 40%, 1% to 30%, 1% to 20%, 1% to 10%, 1% to 15%, 1% to 10%, 1% to 5%, 1% to 2%, 10% to 60%, 10% to 50%, 10% to 40%, 10% to 30%, 10% to 20%, 20% to 60%, 20% to 50%, 20% to 40%, 20% to 30%, 30% to 60%, 30% to 50%, 30% to 40%, 40% to 60%, 40% to 50%, and 50% to 60% of the pesticidal composition by weight, optionally wherein the spinosyn active ingredient is in a range of about 5% to 25% of the pesticidal composition by weight.

8. (canceled)

9. The pesticidal composition of claim 1 further comprising an oil carrier, optionally wherein the oil carrier comprises at least one of: a seed oil, sunflower oil, safflower oil, canola oil, soybean oil, rapeseed oil, cottonseed oil, castor oil, karanja oil, and neem oil or wherein the oil carrier comprises a transesterified derivative at least one of: a seed oil, sunflower oil, safflower oil, canola oil, soybean oil, rapeseed oil, cottonseed oil, castor oil, karanja oil, and neem oil.

10. The pesticidal composition of claim 9 wherein the oil carrier comprises a neutral oil.

11. The pesticidal composition of claim 10 wherein the neutral oil comprises a transesterified oil.

12. (canceled)

13. (canceled)

14. The pesticidal composition of claim 9 wherein the spinosyn active ingredient is less soluble in the oil carrier than in the salicylate solvent, optionally wherein the spinosyn active ingredient is substantially insoluble in the oil carrier.

15. (canceled)

16. The pesticidal composition of claim 1 wherein the spinosyn active ingredient comprises at least one of: spinosyn A, spinosyn B, spinosyn C, spinosyn D, spinosyn E, spinosyn F, spinosyn G, spinosyn H, spinosyn J, spinosyn K, another spinosyn isolate from Saccharopolyspora spinosa culture, spinosad, and derivatives, analogs, or substituents thereof (including but not limited to tetracyclic and pentacyclic spinosyn derivatives, aziridine spinosyn derivatives, C-5,6 and/or C-13,14 substituted spinosyn derivatives); spinetoram (including but not limited to XDE-175-J, XDE-175-L or other O-ethyl substituted spinosyn derivatives); butenyl-spinosyn and derivatives, analogs, or substituents thereof (such as isolates from Saccharopolyspora pogona culture).

17. The pesticidal composition of claim 1 wherein the salicylate solvent comprises at least one of a botanical oil and a hydrophobic botanical extract, in each case comprising an ester.

18. The pesticidal composition of claim 17 wherein the salicylate solvent comprises wintergreen oil.

19. The pesticidal composition of claim 1 wherein the salicylate solvent comprises an ester of salicylic acid.

20. The pesticidal composition of claim 17 wherein the salicylate solvent comprises a salicylate comprising an alkyl group, optionally wherein the salicylate comprises at least one of: methyl salicylate, ethyl salicylate, propyl salicylate, butyl salicylate, pentyl salicylate, and phenyl salicylate.

21. (canceled)

22. The pesticidal composition of claim 1 further comprising a saturated or unsaturated aliphatic acid or an agriculturally or biologically compatible salt thereof.

23. The pesticidal composition of claim 22 wherein the saturated or unsaturated aliphatic acid or an agriculturally or biologically compatible salt thereof comprises at least one of: octanoic acid, decanoic acid, and trans-3-Hexenoic acid or optionally wherein the saturated or unsaturated aliphatic acid or an agriculturally or biologically compatible salt thereof comprises octanoic acid and decanoic acid, optionally wherein a molar ratio of the concentrations of octanoic acid and decanoic acid is between about 1:1 and 2:1.

24. (canceled)

25. (canceled)

26. The pesticidal composition of claim 22 wherein a ratio of the spinosyn active ingredient and the saturated or unsaturated aliphatic acid or an agriculturally or biologically compatible salt thereof is between about 1:5000 and 5000:1 by weight.

27. The pesticidal composition of claim 26 wherein the ratio of the concentrations of the spinosyn active ingredient and the synergist is between at least one of: about 1:1 to 1:10, 1:1 to 1:9, 1:1 to 1:8, 1:1 to 1:7, 1:1 to 1:6, 1:1 to 1:5, 1:1 to 1:4, 1:1 to 1:3, 1:1 to 1:2, 1:1 to 1:1.5, 1.25:1 to 1:10, 1.25:1 to 1:9, 1.25:1 to 1:8, 1.25:1 to 1:7, 1.25:1 to 1:6, 1.25:1 to 1:5, 1.25:1 to 1:4, 1.25:1 to 1:3, 1.25:1 to 1:2, 1.25:1 to 1:1.5, 1:2 to 1:10, 1:2 to 1:9, 1:2 to 1:8, 1:2 to 1:7, 1:2 to 1:6, 1:2 to 1:5, 1:2 to 1:4, 1:2 to 1:3, 1:3 to 1:10, 1:3 to 1:9, 1:3 to 1:8, 1:3 to 1:7, 1:3 to 1:6, 1:3 to 1:5, 1:3 to 1:4, 1:4 to 1:10, 1:4 to 1:9, 1:4 to 1:8, 1:4 to 1:7, 1:4 to 1:6, 1:4 to 1:5, 1:5 to 1:10, 1:5 to 1:9, 1:5 to 1:8, 1:5 to 1:7, 1:5 to 1:6, 1:6 to 1:10, 1:6 to 1:9, 1:6 to 1:8, 1:6 to 1:7, 1:7 to 1:10, 1:7 to 1:9, 1:7 to 1:8, 1:8 to 1:10, 1:8 to 1:9, and 1:9 to 1:10.

28. The pesticidal composition of claim 1 further comprising at least one of: a leaf penetration additive, a leaf spreading additive, a leaf sticking additive, a rainfastening additive, a safening additive, and an encapsulant, optionally further comprising a UV blocking or absorbing additive.

29. (canceled)

30. A pesticidal emulsifiable concentrate comprising:
a spinosyn active ingredient; and
an oil ester solvent operable to dissolve the spinosyn active ingredient.

31.-57. (canceled)

58. A method of making a diluted pesticidal composition comprising:
providing a pesticidal composition which comprises a spinosyn active ingredient and a salicylate solvent in accordance with claim 1; and
diluting the pesticidal composition with a diluent to form a diluted pesticidal composition comprising the spinosyn active ingredient and the salicylate solvent.

59. A method of applying at least one pesticidal composition to control at least one plant pest comprising:
providing a pesticidal composition which comprises a spinosyn active ingredient and a salicylate solvent in accordance with claim 1;
diluting the pesticidal composition with a diluent to form a diluted pesticidal composition comprising the spinosyn active ingredient and the salicylate solvent; and
applying the diluted pesticidal composition to at least one plant, the locus thereof, or propagation material thereof, which is susceptible to or infested with the at least one plant pest.

60. (canceled)

61. (canceled)
